(19) United States
(12) Patent Application Publication
(10) Pub. No.: US 2019/0225768 A1
(43) Pub. Date: Jul. 25, 2019

(54) POLYIMIDE PRECURSOR SOLUTION, METHOD FOR PRODUCING POROUS POLYIMIDE FILM, AND POROUS POLYIMIDE FILM

(71) Applicant: FUJI XEROX CO., LTD., Tokyo (JP)

(72) Inventors: Katsumi NUKADA, Kanagawa (JP); Tomoya SASAKI, Kanagawa (JP); Hidekazu HIROSE, Kanagawa (JP)

(73) Assignee: FUJI XEROX CO., LTD., Tokyo (JP)

(21) Appl. No.: 16/049,832

(22) Filed: Jul. 31, 2018

(30) Foreign Application Priority Data
Jan. 25, 2018 (JP) 2018-010345

(51) Int. Cl. C08J 9/26

(52) U.S. Cl. CPC C08J 9/26; C08J 2379/08; C08J 2205/044; C08J 2201/046

(57) ABSTRACT

A polyimide precursor solution includes an aqueous solution that contains water; a resin particle that does not dissolve in the aqueous solution; inorganic particles that have a volume average particle diameter within a range of 0.001 μm to 0.2 μm; and a polyimide precursor.

### CROSS-REFERENCE TO RELATED APPLICATIONS

This application is based on and claims priority under 35 USC 119 from Japanese Patent Application No. 2018-010345 filed Jan. 25, 2018.

### BACKGROUND

### (i) Technical Field

The present invention relates to a polyimide precursor solution, a method for producing a porous polyimide film, and a porous polyimide film.

### (ii) Related Art

A polyimide resin is a material having excellent characteristics of mechanical strength, chemical stability, and heat resistance, and a porous polyimide film having these characteristics is attracting attention.

For example, JP5331627B discloses a method for manufacturing a lithium secondary battery separator, in which closest packed deposits of monodisperse spherical inorganic particles are sintered to forma sintered body of the inorganic particles, interstices between the inorganic particles of the sintered body are filled with polyamic acid and are sintered thereafter so as to form a polyimide resin, and then, the polyimide resin is immersed into a solution in which the inorganic particles dissolve but the resin does not dissolve so that the inorganic particles dissolves to be removed.

JP2008-034212A discloses an ionic conductor for retaining an electrolyte material that contains an inorganic porous body having pores formed from polyimide and cationic and anionic components in the pores.

JP2012-107144A discloses a method from manufacturing a porous polyimide film, the method including: a step of manufacturing varnish by mixing polyamic acid or polyimide with silica particles and a solvent, or manufacturing varnish by polymerizing polyamic acid or polyimide in a solvent in which silica particles are dispersed; a step of manufacturing a polyimide-silica composite film by forming, on a substrate, the varnish manufactured in the varnish manufacturing step, and then completing imidization; and a step of removing silica of the polyimide-silica composite film manufactured in the composite film manufacturing step.

JP2011-111470A discloses a method for manufacturing porous polyimide, the method including: a step of manufacturing a porous silica mold by filling with silica particles and then sintering to obtain the porous silica mold; a step of filling, with polyimide, voids of the porous silica mold obtained in the porous silica mold manufacturing step; and a step of obtaining porous polyimide by removing silica from the porous silica mold filled with polyimide.

WO2014/196656A discloses a method for manufacturing a porous polyimide film by using a resin particle-dispersed and polyamic acid-mixed solution that contains an aprotic polar solvent which is a good solvent for polyamic acid, resin particles, and a mixed organic solvent such as ethanol which is a poor solvent for polyamic acid.

JP2016-183333A discloses a method for manufacturing a resin particle-dispersed polyimide precursor solution, in which in a resin particle dispersion in which resin particles are dispersed in an aqueous solution, tetracarboxylic dianhydride and a diamine compound are polymerized in the presence of an organic amine compound, thereby forming a polyimide precursor, and discloses a porous polyimide film obtained by using the resin particle-dispersed polyimide precursor solution.

WO2014/057898A and JP2015-199845A disclose a polyimide-silica composite porous body which is obtained by, using a silica precursor such as alkoxy silane, dispersing silica particles having a specific average particle diameter in a porous polyimide having macropores having a specific average pore diameter and mesopores having a specific average pore diameter, and which contains 50% by mass or less of silica components, and further disclose that this composite porous body is effective as a low dielectric constant substrate.

JP2006-338918A discloses a separator for electronic components which is formed by a porous film that has a continuous pores and is formed of a resin material having a synthetic resin having a melting point of 170° C. or higher as a main component and filler particles, in which porous silica particles are contained as the filler particles.

JP2007-204518A discloses a porous film in which silica particles and the like are provided in aromatic polyamide or aromatic polyimide and made to be porous by phase separation and the like, and a coefficient of friction between films is within a specific range.

### SUMMARY

A polyimide precursor solution containing an aqueous solution that contains water; a resin particle that does not dissolve in the aqueous solution; and a polyimide precursor is capable of dispersing the resin particles in the polyimide precursor solution in a nearly homogeneous state. Therefore, by using this polyimide precursor solution, it is possible to obtain a porous film in which nearly homogeneous pores are formed.

In a case of forming a porous polyimide film by applying the polyimide precursor solution on a substrate in order to continuously form the film (hereinafter, continuously formed film will be referred to as “continuous film”), adhesiveness of the porous polyimide film to the substrate is strong, and thus peelability from the substrate deteriorates in some cases. In a case of attempting to peel off the porous polyimide film from the substrate in the case where the peelability deteriorates, the porous polyimide film ruptures in some cases. In addition, in a case where dispersibility of the resin particles is low, pinholes are generated in the obtained porous polyimide film in some cases.

Aspects of non-limiting embodiments of the present disclosure relate to a polyimide precursor solution capable of obtaining a porous polyimide film in which generation of pinholes are suppressed, and peelability from a substrate is improved, compared to a case in which a polyimide precursor solution merely contains an aqueous solution that contains water, resin particles that does not dissolve in the aqueous solution containing water, an organic amine compound, and a polyimide precursor, and a case in which a polyimide precursor solution merely contains an aqueous solution that contains water, resin particles that does not dissolve in the aqueous solution containing water, an organic amine compound, silica particles that have a volume average particle diameter more than 0.2 μm, and a polyimide precursor, in a polyimide precursor solution containing resin particles.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided a polyimide precursor solution including: an aqueous solution that contains water; a resin particle that does not dissolve in the aqueous solution; inorganic particles that have a volume average particle diameter within a range of 0.001 μm to 0.2 μm; and a polyimide precursor.

### BRIEF DESCRIPTION OF THE DRAWINGS

Exemplary embodiment(s) of the present invention will be described in detail based on the following figures, wherein:

FIG. 1 is a schematic diagram showing a form of a porous polyimide film obtained by using a polyimide precursor solution of this exemplary embodiment.

### DETAILED DESCRIPTION

Hereinafter, an exemplary embodiment that is an example of the invention will be described.

Polyimide Precursor Solution

A polyimide precursor solution according to this exemplary embodiment includes a polyimide precursor solution including: an aqueous solution that contains water; a resin particle that does not dissolve in the aqueous solution; inorganic particles that have a volume average particle diameter within a range of 0.001 μm to 0.2 μm; and a polyimide precursor.

In this specification, the phrase “does not dissolve” means that a target substance dissolves in a target liquid at 25° C. by a range of 3% by mass or less.

A polyimide film is obtained by, for example, application of a solution in which the polyimide precursor has dissolved in an organic solvent (for example, a solution in a state where the polyimide precursor has dissolved in a highly polar organic solvent such as N-methylpyrrolidone (hereinafter, will be referred to as “NMP” in some cases), and N,N-dimethylacetamide (hereinafter, will be referred to as “DMAc” in some cases)), followed by heating and molding.

In order to form a continuous film of the polyimide film, a porous film is formed by using a substrate. Examples of the substrate include a metal substrate (substrate made of metal; endless belt and the like made of metal), and in many cases, the continuous film is produced by applying, on the metal substrate, the solution in which the polyimide precursor has dissolved in the organic solvent, followed by heating and molding.

In particular, in a case of using the metal substrate as a substrate, there is a case where adhesiveness of the polyimide film to the metal substrate is strong, and thus the film becomes unlikely to be peeled off. Therefore, for a purpose of improving peelability, a release agent such as silicone oil and aliphatic phosphate is used.

Meanwhile, in regard to the polyimide precursor solution containing the aqueous solution that contains water, the resin particle that does not dissolve in the aqueous solution, and the polyimide precursor, resin particles are capable of being dispersed in a state close to homogeneous dispersion in the polyimide precursor solution. In the porous polyimide film obtained by using the polyimide precursor solution, uniformly distributed pores are formed. In the case of using the polyimide precursor solution, for forming the continuous film of the porous polyimide film, the continuous film is also produced by applying, on the substrate, the polyimide precursor solution in which the resin particles are dispersed, followed by heating and molding, in many cases.

In a case of applying the release agent (silicone oil and the like) on the substrate, in the resin particle-dispersed polyimide precursor solution, the polyimide precursor dissolves by use of the aqueous solution, and therefore crawling is generated on a coated film of the resin particle-dispersed polyimide precursor solution in some cases. On the other hand, in a case of not applying the release agent on the substrate, the adhesiveness of the polyimide film subjected to heating and molding to the substrate becomes strong, and thus the peelability deteriorates in some cases. In addition, in the case where the peelability deteriorates, in a case of attempting to peel off the porous polyimide film from the substrate, the porous polyimide film ruptures in some cases. In particular, in the case of using the metal substrate as the substrate, a tendency that these phenomena being more frequently observed is remarkable.

The porous polyimide film is formed by using the polyimide precursor solution in which particles such as inorganic particles and resin particles are mixed as necessary. For example, in a case where the inorganic particles are mixed to the solution in which the polyimide precursor has dissolved in the highly polar organic solvent, and thus a particle-dispersed polyimide precursor solution is prepared, dispersibility of the inorganic particles in the polyimide precursor solution becomes low in some cases.

On the other hand, in a case where the resin particles are mixed to the solution in which the polyimide precursor has dissolved in the highly polar organic solvent, in a case of general resin particles (for example, polystyrene resin particles and the like), there is a case where the resin particles dissolve in the highly polar organic solvent, and thus dispersibility of the resin particles in the polyimide precursor solution becomes low. In addition, for example, in a case where resin particles that are unlikely to dissolve in the highly polar organic solvent is prepared by emulsion polymerization and the like, there is a case where replacement with the highly polar organic solvent is performed so as to mix the resin particles to the solution in which the polyimide precursor has dissolved in the highly polar organic solvent. In this case, in order to perform the replacement with the highly polar organic solvent, there is a case where the resin particles are taken out from the resin particle dispersion, but in some cases, the taken out resin particles agglomerate, and thus the dispersibility becomes low. In addition, in the polyimide precursor solution containing the aqueous solution that contains water, the resin particle that does not dissolve in the aqueous solution, and the polyimide precursor, there is a case where the dispersibility of the resin particles is low, and an agglomerate of the resin particles is generated.

Furthermore, for example, in a case where the porous polyimide film is formed by using the polyimide precursor solution in which the agglomerate of the resin particles has been generated, a pinhole is generated in the porous polyimide film in some cases.

In this specification, the pinhole is distinguished from a pore resulted from the removal of the resin particles. The pinhole represents a through-hole penetrating from a surface to a rear surface. Specifically, the pinhole is a visually observable hole having a diameter of about 0.1 mm or larger and 0.5 mm or smaller, which is the diameter larger than a diameter of the resin particle used.

With respect to the above description, with the polyimide precursor solution according to this exemplary embodiment which has the above configuration, the generation of the pinholes is suppressed, and the peelability from the substrate is improved. The reason for these effects is not clear, but is presumed as follows.

In a case where the inorganic particles that has a volume average particle diameter of 0.001 μm or larger and 0.2 μm or smaller is contained in addition to the aqueous solution that contains water, the resin particle that does not dissolve in the aqueous solution, and the polyimide precursor, inorganic particles are dispersed in the polyimide precursor solution. After the polyimide precursor solution in which the inorganic particles are dispersed is applied on the substrate, heating and molding are performed, and on the substrate side of a porous polyimide film thus obtained, the inorganic particles are present. It is presumed that the inorganic particles present on the surface of the porous polyimide film are in contact with the substrate, by which a contact area of the porous polyimide film and the substrate is reduced, and therefore the peelability from the substrate is improved. It is considered that the peelability, from the substrate, of the porous polyimide film obtained by using the polyimide precursor solution according to this exemplary embodiment, is improved due the above-described action, and therefore even in the case of using the metal substrate as a substrate, the peelability from the metal substrate is improved.

In addition, it is considered that even in the case where the inorganic particles that have a volume average particle diameter within a range of 0.001 μm to 0.2 μm is contained, a deterioration of the dispersibility of the resin particles in the polyimide precursor solution is suppressed, and therefore the agglomerate of the resin particles is suppressed. Therefore, it is presumed that the generation of the pinholes in the porous polyimide film is suppressed.

Based on the above description, it is presumed that with the polyimide precursor solution according to this exemplary embodiment which has the above configuration, in the porous polyimide film formed by using the polyimide precursor solution according to this exemplary embodiment, the generation of the pinholes is suppressed, and the peelability from the substrate is improved.

In a first step, a coated film is formed using the polyimide precursor solution according to this exemplary embodiment and is dried so as to form a dried coat film, and in a second step, the dried coat film is heated and imidization is performed, and through a process of removing the resin particles in the second step, the porous polyimide film of this exemplary embodiment is obtained. In the porous polyimide film obtained by this production method, it is easy to control variations in distribution of pores. In addition, it is easy to control variations in a pore shape, a pore diameter, and the like. The reason is presumed as follows.

It is considered that in the polyimide precursor solution according to this exemplary embodiment, the dispersibility of the resin particles and the inorganic particles having the volume average particle diameter within a range of 0.001 μm to 0.2 μm is improved, and therefore in regard to the porous polyimide film from which the resin particles have been removed, it is easy to control variations in distribution of the pores.

In addition, it is considered that by using the resin particles, it is easy to control variations in the pore shape, the pore diameter, and the like. It is considered that the reason for the above description is that relaxation of residual stresses due to volumetric shrinkage also effectively contributes in the step of imidizing the polyimide precursor.

Furthermore, a boiling point of the polyimide precursor solution is about 100° C. so that the polyimide precursor dissolves in the aqueous solution. For this reason, after heating of the coat containing the polyimide precursor, the resin particles, and the silica particles, accompanied by prompt volatilization of the solvent, the imidization reaction progresses. Then, before deformation of the resin particles in the coat occurs due to heat, the resin particles lose fluidity and become insoluble in the organic solvent. Therefore, it is considered that retention of the pore shape becomes easy.

Furthermore, the occurrence of cracks is easily suppressed in the porous polyimide film of this exemplary embodiment obtained by forming, by using the polyimide precursor solution according to this exemplary embodiment, the polyimide film containing the resin particles and the inorganic particles that has the volume average particle diameter within a range of 0.001 μm to 0.2 μm, and removing the resin particles. It is considered that, in the method for producing the porous polyimide film of this exemplary embodiment, in the step of imidizing the polyimide precursor, the use of the inorganic particles having the volume average particle diameter within a range of 0.001 μm to 0.2 μm, allows the polyimide precursor solution to become a state of a nanocomposite (composite material in which nanoparticles are dispersed) in which the inorganic particles are dispersed, and therefore it is presumed that this condition effectively contributes to relaxation of residual stresses and improvement in strength.

Hereinafter, the polyimide precursor solution according to this exemplary embodiment and the method for producing thereof will be described.

Method for Producing Polyimide Precursor Solution

Examples of the method for producing the polyimide precursor solution according to this exemplary embodiment include the following method.

First, a resin particle dispersion in which the resin particles are dispersed in the aqueous solution is prepared. Thereafter, the inorganic particles having the volume average particle diameter within a range of 0.001 μm to 0.2 μm are dispersed in the resin particle dispersion, and then, for example, in the presence of an organic amine compound, tetracarboxylic dianhydride and a diamine compound are polymerized, and therefore the polyimide precursor is formed. Hereinafter, the case in which the reaction is performed in the presence of the organic amine compound will be described.

Specifically, the case includes a step of preparing the resin particle dispersion in which the resin particles are dispersed in the aqueous solution (hereinafter will be referred to as “resin particle dispersion preparation step” in some cases), a step of adding and dispersing the inorganic particles having the volume average particle diameter within a range of 0.001 μm to 0.2 μm in the resin particle dispersion (hereinafter will be referred to as “inorganic particle dispersing step” in some cases), and a step of mixing the organic amine compound, tetracarboxylic dianhydride, and a diamine compound, and polymerizing the tetracarboxylic dianhydride and the diamine compound so as to form the polyimide precursor (hereinafter will be referred to as “polyimide precursor formation step” in some cases).

In the method for producing the polyimide precursor solution, to the solution in which the polyimide precursor is dissolved in the aqueous solution containing water in advance, the resin particles (resin particles in a dry state or resin particles dispersed in the aqueous solution containing water), and the inorganic particles having the volume average particle diameter within a range of 0.001 μm to 0.2 μm (inorganic particles in a dry state or inorganic particles dispersed in the aqueous solution containing water) may be added so as to be dispersed.

The polyimide precursor solution of this exemplary embodiment is obtained in one system (for example, in one container) which is from the preparation of the resin particle dispersion to the preparation of the polyimide precursor solution, and therefore the step of producing the polyimide precursor solution is simplified. In addition, the polyimide precursor solution is handled without drying and taking out the resin particles, and therefore it possible to prevent the agglomerate from being generated when drying the resin particles. From the above viewpoint, for example, it is preferable that the polyimide precursor is formed in the particle dispersion in which the resin particles, and the inorganic particles having the volume average particle diameter within a range of 0.001 μm to 0.2 μm are dispersed in the aqueous solution in advance.

Resin Particle Dispersion Preparation Step

As long as the resin particle dispersion in which the resin particles are dispersed in the aqueous solution is obtained, a method of the resin particle dispersion preparation step is not particularly limited.

Examples thereof include a method in which the resin particles that do not dissolve in the polyimide precursor solution, and the aqueous solution for the resin particle dispersion are weighed respectively, mixed, and stirred, and therefore the resin particle dispersion is obtained. The method in which the resin particles and the aqueous solution are mixed and stirred is not particularly limited. Examples thereof include a method in which the resin particles and the aqueous solution are mixed while stirring the aqueous solution, and the like. In addition, from the viewpoint of improving the dispersibility the resin particles, for example, at least one of an ionic surfactant or a nonionic surfactant may be mixed thereto.

Furthermore, the resin particle dispersion may be a resin particle dispersion obtained by granulating the resin particles in the aqueous solution. In the case of granulating the resin particles in the aqueous solution, a resin particle dispersion formed by polymerizing a monomer component in the aqueous solution may be produced. In this case, the resin particle dispersion may be a dispersion obtained by a known polymerization method. For example, in a case where the resin particles are vinyl resin particles, known polymerization methods (radical polymerization methods such as emulsion polymerization, soap-free emulsion polymerization, suspension polymerization, miniemulsion polymerization, and microemulsion polymerization) may be applied.

For example, in the case of applying the emulsion polymerization method to produce the vinyl resin particles, to water in which a water-soluble polymerization initiator such as potassium persulfate, or ammonium persulfate is dissolved, a monomer having a vinyl group such as styrenes or (meth) acrylic acids is added, and a surfactant such as sodium dodecyl sulfate or diphenyl oxide disulfonates is further added thereto as necessary, the polymerization is carried out by heating while stirring, and therefore the vinyl resin particles are obtained. Using a monomer having an acidic group as a monomer component, a vinyl resin having an acidic group on a surface thereof is obtained. For example, the case where the resin particle has an acidic group on the surface thereof is preferable because the dispersibility of the resin particles is improved.

In the resin particle dispersion formation step, a method is not limited to the above-described method, and a commercially available resin particle dispersion in which the resin particles are dispersed in the aqueous solution may be prepared. In addition, in a case of using the commercially available resin particle dispersion, an operation such as dilution with the aqueous solution may be carried out depending on the purpose. Furthermore, within a range not affecting the dispersibility, in the dispersion in which the resin particles are dispersed in the organic solvent, the organic solvent may be replaced with an aqueous solution.

Inorganic Particle Dispersion Step

As long as a dispersion in which the inorganic particles having the volume average particle diameter within a range of 0.001 μm to 0.2 μm are dispersed in the aqueous solution is obtained in the resin particle dispersion in which the resin particles are dispersed (that is, as long as a dispersion in which the resin particles and the inorganic particles are dispersed is obtained), a method of the inorganic particle dispersion step is not particularly limited.

In the inorganic particle dispersion step, the resin particle dispersion in which the resin particles are dispersed may be mixed with the inorganic particles of a dry state so as to obtain the dispersion in which the resin particles and the inorganic particles are dispersed. The resin particle dispersion in which the resin particles are dispersed may be mixed with the inorganic particle dispersion in which the inorganic particles are dispersed so as to obtain the dispersion in which the resin particles and the inorganic particles are dispersed. From the viewpoint of the dispersibility, for example, it is preferable that the resin particle dispersion in which the resin particles are dispersed is mixed with an aqueous solution dispersion of the inorganic particles so as to obtain the dispersion in which the resin particles and the inorganic particles are dispersed.

Polyimide Precursor Formation Step

Next, in the dispersion in which the resin particles and the inorganic particles are dispersed, for example, in the presence of the organic amine compound, tetracarboxylic dianhydride and a diamine compound are polymerized so as to generate a resin (polyimide precursor), and therefore the polyimide precursor solution is formed.

According to this method, since the aqueous solution is applied, productivity is high, and the polyimide precursor solution is produced in one step, which is, for example, preferable from the viewpoint of simplifying the steps.

Specifically, to the dispersion in which the resin particles and the inorganic particles are dispersed, which is prepared in the resin particle dispersion preparation step and the inorganic particle dispersion step, the organic amine compound, the tetracarboxylic dianhydride, and the diamine compound are mixed. Thereafter, for example, in the presence of the organic amine compound, the tetracarboxylic dianhydride and the diamine compound are polymerized, and therefore the polyimide precursor is formed in the resin particle dispersion. An order of mixing the organic amine compound, the tetracarboxylic dianhydride, and the diamine compound in the resin particle dispersion is not particularly limited.

In the case where the tetracarboxylic dianhydride and the diamine compound are polymerized in the resin particle dispersion in which the resin particles and the inorganic particles are dispersed, the aqueous solution in the resin particle and inorganic particle dispersion may be used as it is so as to form the polyimide precursor. In addition, an aqueous solution may be newly mixed as necessary. In the case of newly mixing an aqueous solution, the aqueous solution may be an aqueous solution containing a small amount of an aprotic polar solvent. In addition, other additives may be mixed depending on the purpose.

According to the above-described steps, the polyimide precursor solution in which the resin particles, and the inorganic particles having the volume average particle diameter within a range of 0.001 μm to 0.2 μm are dispersed is obtained (hereinafter will be referred to as “resin particle and inorganic particle-dispersed polyimide precursor solution” in some cases).

Next, materials constituting the resin particle and inorganic particle-dispersed polyimide precursor solution will be described.

Aqueous Solution Containing Water

In the regard to the aqueous solution, in the case where the tetracarboxylic dianhydride and the diamine compound are polymerized in the resin particle and inorganic particle dispersion, the resin particles, and the aqueous solution in the inorganic particle dispersion, which are used in the preparation of the resin particle and inorganic particle dispersion may be used as they are. In addition, in the case of polymerizing the tetracarboxylic dianhydride and the diamine compound, the aqueous solution may be prepared so as to be suitable for the polymerization.

The aqueous solution is the aqueous solution containing water. Specifically, the aqueous solution is not limited and is preferably a solvent in which water is contained by 50% by mass or more with respect to a total content of the aqueous solution. Examples of the water include distilled water, ion exchange water, ultrafiltered water, pure water, and the like.

A content of the water is, for example, preferably 50% by mass or more and 100% by mass or less, more preferably 70% by mass or more and 100% by mass or less, and even more preferably 80% by mass or more 100% by mass or less with respect to the entire aqueous solution.

The aqueous solution used in the case of preparing the resin particle dispersion is the aqueous solution containing the water. Specifically, the aqueous solution for the resin particle dispersion is not limited and is preferably the aqueous solution in which water is contained by 50% by mass or more with respect to the entire aqueous solution. Examples of the water include distilled water, ion exchange water, ultrafiltered water, pure water, and the like.

In addition, in a case where a soluble organic solvent other than the water is contained, for example, a water-soluble alcohol solvent may be used. The term “water-soluble” means that a target substance is dissolved by 1% by mass or more with respect to the water at 25° C.

In the case where the aqueous solution contains the solvent other than the water, examples of the solvent other than water include the water-soluble organic solvent or the aprotic polar solvent. As the solvent other than the water, for example, the water-soluble organic solvent is preferable from the viewpoints of transparency, mechanical strength, and the like of the polyimide film. In particular, from the viewpoint of improving various properties of the polyimide film such as heat resistance, electrical properties, and solvent resistance in addition to the transparency and the mechanical strength, the aqueous solution may contain the aprotic polar solvent. In this case, for preventing dissolution and swelling of the resin particles in the resin particle and inorganic particle-dispersed polyimide precursor solution, a content of the solvent is, for example, preferably 40% by mass or less, and more preferably 30% by mass or less with respect to the entire aqueous solution. In addition, for preventing dissolution and swelling of the resin particles in the case of drying the polyimide precursor solution so as to make the film, for example, the solvent is preferably used by 5% by mass or more and 300% by mass or less, more preferably 5% by mass or more and 250% by mass or less, and even more preferably 5% by mass or more and 200% by mass or less with respect to a solid content of the polyimide precursor in the polyimide precursor solution. The term “water-soluble” means that a target substance is dissolved by 1% by mass or more with respect to the water at 25° C.

The water-soluble organic solvent may be used alone or in combination of two or more thereof.

As the water-soluble organic solvent, for example, a water-soluble organic solvent in which the resin particles do not dissolve is preferable, which is to be described below. The reason for this is because, for example, in a case where the aqueous solution containing the water and the water-soluble organic solvent is used, there is a concern that the resin particles dissolve during the process of producing the film even in a case where the resin particles do not dissolve in the resin particle dispersion, and therefore the water-soluble organic solvent may be used within a range capable of suppressing dissolution and swelling of the resin particles during the process of producing the film.

A water-soluble ether solvent is a water-soluble solvent having an ether bond in one molecule. Examples of the water-soluble ether solvent include tetrahydrofuran (THF), dioxane, trioxane, 1,2-dimethoxyethane, diethylene glycol dimethyl ether, diethylene glycol diethyl ether, and the like. Among these, for example, tetrahydrofuran and dioxane are preferable as the water-soluble ether solvent.

A water-soluble ketone solvent is a water-soluble solvent having a ketone group in one molecule. Examples of the water-soluble ketone solvent include acetone, methyl ethyl ketone, cyclohexanone, and the like. Among these, for example, acetone is preferable as the water-soluble ketone solvent.

A water-soluble alcohol solvent is a water-soluble solvent having an alcoholic hydroxyl group in one molecule. Examples of the water-soluble alcohol solvent include methanol, ethanol, 1-propanol, 2-propanol, tert-butyl alcohol, ethylene glycol, monoalkyl ether of ethylene glycol, propylene glycol, monoalkyl ether of propylene glycol, diethylene glycol, monoalkyl ether of diethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol, and the like. Among these, as the water-soluble alcohol solvent, for example, methanol, ethanol, 2-propanol, ethylene glycol, monoalkyl ether of ethylene glycol, propylene glycol, monoalkyl ether of propylene glycol, diethylene glycol, monoalkyl ether of diethylene glycol are preferable.

In a case where the aprotic polar solvent other than water is contained as the aqueous solution, the aprotic polar solvent to be used in combination is a solvent having a boiling point of 150° C. or higher and 300° C. or lower and a dipole moment of 3.0 D or more and 5.0 D or less. Specific examples of the aprotic polar solvent include N-methyl-2-pyrrolidone (NMP), N,N-dimethylformamide (DMF), N,N-dimethylacetamide (DMAc), dimethylsulfoxide (DMSO), hexamethylenephosphoramide (HMPA), N-methylcaprolactam, N-acetyl-2-pyrrolidone, 1,3-dimethyl-2-imidazolidinone (DMI), N,N′-dimethylpropyleneurea, tetramethylurea, trimethyl phosphate, triethyl phosphate, and the like.

In the case where the solvent other than the water is contained as the aqueous solution, the solvent to be used in combination preferably has the boiling point of 270° C. or lower, more preferably 60° C. or higher and 250° C. or lower, and even more preferably 80° C. or higher and 230° C. or lower, for example. In the case where the boiling point of the solvent to be used in combination is within the above range, it becomes difficult for the solvent other than water to remain in the polyimide film, and the polyimide film having high mechanical strength is easily obtained.

A range in which the polyimide precursor dissolves in the solvent is controlled by a content of the water, a type and an amount of the organic amine compound. In a range in which the content of the water is small, the polyimide precursor is likely to dissolve in a region where a content of the organic amine compound is small. Conversely, in a range in which the content of the water is large, the polyimide precursor is likely to dissolve in a region where the content of the organic amine compound is large. In addition, in a case where the organic amine compound exhibits high hydrophilicity such as having a hydroxyl group, the polyimide precursor is likely to dissolve in a region where the content of the water is large.

Resin Particle

The resin particle is not particularly limited as long as the resin particle does not dissolve in the aqueous solution and does not dissolve in the polyimide precursor solution, and is a resin particle made of a resin other than polyimide. Examples thereof include a resin particle obtained by polycondensation of polymerizable monomers such as a polyester resin and a urethane resin, and a resin particle obtained by radical polymerization of polymerizable monomers such as a vinyl resin, an olefin resin, and a fluorine resin. Examples of the resin particle obtained by radical polymerization include a resin particle of a (meth)acrylic resin, a (meth)acrylic ester resin, a styrene-(meth)acrylic resin, a polystyrene resin, a polyethylene resin, and the like.

Among these, for example, it is preferable that the resin particle is at least one selected from the group consisting of a (meth)acrylic resin, a (meth)acrylic ester resin, a styrene-(meth)acrylic resin, and a polystyrene resin.

In this exemplary embodiment, the term “(meth)acrylic” means to include both “acrylic” and “methacrylic.”

In addition, the resin particles may be cross-linked or may not be cross-linked. In the step of imidizing the polyimide precursor, for example, the resin particles which are not cross-linked are preferable in terms of effectively contributing to relaxation of the residual stresses. In addition, for example, the resin particle dispersion is more preferably a vinyl resin particle dispersion obtained by emulsion polymerization from the viewpoint of simplifying the steps of producing the resin particle-dispersed polyimide precursor solution.

In the case where the resin particles are the vinyl resin particles, for example, the vinyl resin particles may be obtained by polymerizing monomers. Examples of the monomers of the vinyl resin include the following monomers. Examples thereof include vinyl resin units in which monomers are polymerized, such as styrenes having a styrene skeleton such as styrene, alkyl-substituted styrene (such as α-methylstyrene, 2-methylstyrene, 3-methylstyrene, 4-methylstyrene, 2-ethylstyrene, 3-ethylstyrene, and 4-ethylstyrene), halogen-substituted styrene (such as 2-chlorostyrene, 3-chlorostyrene, and 4-chlorostyrene), and vinyl naphthalene; esters having a vinyl group such as methyl (meth)acrylate, ethyl (meth)acrylate, n-propyl (meth)acrylate, n-butyl (meth)acrylate, lauryl (meth)acrylate, 2-ethylhexyl (meth)acrylate, and trimethylolpropane trimethacrylate (TMPTMA); vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as a (meth)acrylic acid, a maleic acid, a cinnamic acid, a fumaric acid, and a vinylsulfonic acid; bases such as ethyleneimine, vinylpyridine, and vinylamine; and the like.

As other monomers, a monofunctional monomer such as vinyl acetate, a bifunctional monomer such as ethylene glycol dimethacrylate, nonanediacrylate, and decanediol diacrylate, and a polyfunctional monomer such as trimethylolpropane triacrylate and trimethylolpropane trimethacrylate may be used in combination.

In addition, the vinyl resin may be a resin using these monomers alone, or may be a resin that is a copolymer using two or more of the monomers.

For example, the resin particles preferably have an acidic group on the surface thereof from the viewpoint of improving the dispersibility and suppressing the generation of the pinholes. It is considered that the acidic group present on the surface of the resin particle functions as a dispersant for the resin particles by forming a salt with a base of the organic amine compound and the like used for dissolving the polyimide precursor in the aqueous solution. Therefore, it is considered that the dispersibility of the resin particles in the polyimide precursor solution is improved.

The acidic group present on the surface of the resin particle is not particularly limited, but may be at least one selected from the group consisting of a carboxy group, a sulfonic acid group, and a phenolic hydroxyl group. Among these, for example, the carboxy group is preferable.

The monomer that allows the acidic group to be provided on the surface of the resin particles is not particularly limited as long as the monomer is a monomer having the acidic group. Examples thereof include a monomer having a carboxy group, a monomer having a sulfonic acid group, a monomer having a phenolic hydroxyl group, and salts thereof.

Specific examples thereof include a monomer having a sulfonic acid group such as a p-styrene sulfonic acid and a 4-vinylbenzene sulfonic acid; a monomer having a phenolic hydroxyl group such as a 4-vinyldihydro-cinnamic acid, and 4-vinylphenol, 4-hydroxy-3-methoxy-1-propenylbenzene; a monomer having a carboxy group such as an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate; and salts thereof. These monomers having the acidic group may be mixed with a monomer not having the acidic group and polymerized, or a monomer not having the acidic group may be polymerized and particulated, and then the monomer having the acidic group on the surface of the monomer may be polymerized. In addition, these monomers may be used alone or in combination of two or more kinds thereof.

Among these, for example, a monomer having a carboxy group such as an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate, and salts thereof, is preferable. The monomer having a carboxy group may be used alone or in combination of two or more kinds thereof.

That is, for example, it is preferable that the resin particle having the acidic group on the surface thereof has a skeleton derived from the monomer having at least one carboxy group selected from the group consisting of an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate, and salts thereof.

In the case where the monomer having the acidic group and the monomer not having the acidic group are mixed and polymerized, an amount of the monomer having the acidic group is not particularly limited, but in a case where the amount of the monomer having the acidic group is excessively small, the dispersibility of the resin particles in the polyimide precursor solution deteriorates in some cases, whereas in a case where the amount of the monomer having the acidic group is excessively large, an aggregate of a polymer is generated in some cases when performing the emulsion polymerization. Therefore, an amount of the monomer having the acidic group is, for example, preferably 0.3% by mass or more and 20% by mass or less, more preferably 0.5% by mass or more and 15% by mass or less, and particularly preferably 0.7% by mass or more and 10% by mass or less with respect to a total amount of the monomers.

Meanwhile, in the case where the monomer not having the acidic group is subjected to the emulsion polymerization, and then the monomer having the acidic group is added thereto and polymerized, from the same viewpoint described above, the amount of the monomer having the acidic group is, for example, preferably 0.01% by mass or more and 10% by mass or less, more preferably 0.05% by mass or more and 7% by mass or less, and particularly preferably 0.07% by mass or more and 5% by mass or less with respect to the total amount of the monomers.

As described above, for example, it is preferable that the resin particles are not cross-linked, but when the resin particles are cross-linked, in a case of using a cross-linking agent as at least a part of monomer components, a percentage of the cross-linking agent accounting for total monomer components is, for example, preferably 0% by mass or more and 20% by mass or less, more preferably 0% by mass or more and 5% by mass or less, and particularly preferably 0% by mass.

In a case where the monomer used for the resin constituting the vinyl resin particles contains styrene, a percentage of styrene accounting for the total monomer components is, for example, preferably 20% by mass or more and 100% by mass or less, and more preferably 40% by mass or more and 100% by mass or less.

An average particle diameter of the resin particles is not particularly limited. For example, the average particle diameter is preferably 0.1 μm or larger and 1.0 μm and smaller, more preferably 0.25 μm or larger and 0.98 μm or smaller, and even more preferably 0.25 μm or larger and 0.95 μm or smaller. In the case where the average particle diameter of the resin particles is within the above range, the productivity of the resin particles is improved, and thus the suppression of aggregating properties becomes easy. Furthermore, the suppression of the generation of the pinholes in the porous polyimide film becomes easy. From the same viewpoint, for example, it is preferable that the average particle diameter of the resin particles is larger than the volume average particle diameter of the inorganic particles to be described later.

As the average particle diameter of the resin particles, a particle size distribution obtained by measurement with a laser diffraction type particle size distribution measuring apparatus (for example, COULTER COUNTER LS13 described above, manufactured by Beckman Coulter, Inc.) is used, a cumulative distribution is subtracted from a divided particle size range (channel), from a smaller particle diameter in the volume, and a particle diameter accumulating 50% of all the particles is measured as a volume average particle diameter D50v.

The resin particles may be particles obtained by polymerizing the monomers having the acidic group on the surface of commercially available products. Specific examples of the cross-linked resin particles include cross-linked polymethyl methacrylate (MBX-series, manufactured by Sekisui Plastics Co., Ltd.), cross-linked polystyrene (SBX-series, manufactured by Sekisui Plastics Co., Ltd.), copolymerized cross-linked resin particles of methyl methacrylate and styrene (MSX-series, manufactured by Sekisui Plastics Co., Ltd.), and the like.

In addition, examples of the non-crosslinked resin particles include polymethyl methacrylate (MB-series, manufactured by Sekisui Plastics Co., Ltd.), (meth)acrylic ester-styrene copolymer (FS-series, manufactured by Nippon Paint Co., Ltd.), and the like.

In the polyimide precursor solution, a content of the resin particles is, for example, preferably within a range of 20 parts by mass to 600 parts by mass (for example, more preferably 25 parts by mass or more and 550 parts by mass or less, and even more preferably 30 parts by mass or more and 500 parts by mass or less) with respect to a solid content of 100 parts by mass of the polyimide precursor in the polyimide precursor solution.

Inorganic Particle

The volume average particle diameter of the inorganic particles is 0.001 μm or more and 0.2 μm or less. From the viewpoints of suppressing the generation of the pinholes and improving the peelability from the substrate, the volume average particle diameter of the inorganic particles is, for example, preferably 0.004 μm or more and 0.1 μm or less, and more preferably 0.005 μm or more and 0.08 μm or less.

The volume average particle diameter of the inorganic particles is measured by the same method of the above-described method for measuring the volume average particle diameter of the resin particles.

The inorganic particles having the volume average particle diameter within a range of 0.001 μm to 0.2 μm is not particularly limited as long as the inorganic particles have the volume average particle diameter satisfying the above range. Specific examples of the inorganic particle include a silica particle, a titanium oxide particle, an aluminum oxide particle, and the like. Among these, as the inorganic particle, the silica particle is, for example, preferable from the viewpoint of the dispersibility, and the like.

The silica particle may be sol-gel silica obtained by a sol-gel method or may be fumed silica obtained by vapor-phase method. In addition, as the silica particles, particles may be synthesized or commercially available products may be used. Furthermore, the silica particles may be an aqueous solution dispersion (for example, SNOWTEX (registered trademark) series manufactured by Nissan Chemical Industries, Ltd.) or a dry powder (for example, AEROSIL series manufactured by Evonik). From the viewpoint of the dispersibility, for example, it is preferable to use an aqueous dispersion for the silica particles.

In the polyimide precursor solution, from the viewpoint of improving the peelability from the substrate, a content of the inorganic particles of 0.001 μm or larger and 0.2 μm or less is, for example, preferably 3 parts by mass or more and 50 parts by mass or less, more preferably within a range of 5 parts by mass to 30 parts by mass, and even more preferably within a range of 10 parts by mass to 25 parts by mass with respect to the solid content of 100 parts by mass of the polyimide precursor in the polyimide precursor solution.

In the polyimide precursor solution, a mass ratio (resin particles/inorganic particles) of the above-described resin particles and the inorganic particles is, for example, preferably 100/0.5 or more and 100/100 or less, and more preferably 100/0.9 or more and 100/20 or less, from the viewpoints of suppressing the generation of the pinholes and the peelability of the substrate.

Polyimide Precursor

The polyimide precursor is obtained by the polymerization of tetracarboxylic dianhydride and a diamine compound. Specifically, the polyimide precursor is a resin (polyamic acid) having a repeating unit represented by General Formula (I).

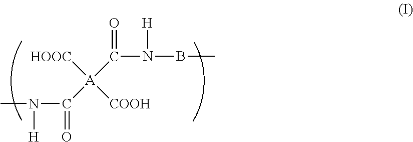

In General Formula, A represents a tetravalent organic group, and B represents a divalent organic group.

In General Formula (I), the tetravalent organic group represented by A is a residue of the tetracarboxylic dianhydride as a raw material, from which four carboxy groups are removed.

Meanwhile, the divalent organic group represented by B is a residue of the diamine compound as a raw material, from which two amino groups are removed.

That is, the polyimide precursor having the repeating unit represented by General Formula (I) is a polymer of the tetracarboxylic dianhydride and the diamine compound.

Examples of the tetracarboxylic dianhydride include any compound of aromatic and aliphatic compounds, but the aromatic compound is preferable. That is, in General Formula (I), the tetravalent organic group represented by A is not limited and is preferably an aromatic organic group.

Examples of the aromatic tetracarboxylic dianhydride include pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furan tetracarboxylic dianhydride, 4,4′-bis(3,4-dicarboxyphenoxy) diphenyl sulfide dianhydride, 4,4′-bis(3,4-dicarboxyphenoxy) diphenyl sulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic acid)phenyl phosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride, and the like.

Examples of the aliphatic tetracarboxylic dianhydride include aliphatic or alicyclic tetracarboxylic dianhydride such as butane tetracarboxylic dianhydride, 1,2,3,4-cyclobutane tetracarboxylic dianhydride, 1,3-dimethyl-1,2,3,4-cyclobutane tetracarboxylic dianhydride, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-di carboxylic dianhydride, and bicyclo[2,2,2]-oct-7-ene-2,3,5,6-tetracarboxylic dianhydride; an aliphatic tetracarboxylic dianhydride having an aromatic ring such as 1,3,3a,4,5,9b-hexahydro-(2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione; and the like.

Among these, as the tetracarboxylic dianhydride, although there is no particular limitation, the aromatic tetracarboxylic dianhydride is preferable, and specific examples are more preferably pyromellitic dianhydride, 3,3′,4,4′-biphenyl tetracarboxylic dianhydride, 2,3,3′,4′-biphenyl tetracarboxylic dianhydride, 3,3′,4,4′-biphenyl ether tetracarboxylic dianhydride, and 3,3′,4,4′-benzophenone tetracarboxylic dianhydride, even more preferably pyromellitic dianhydride, 3,3′,4,4′-biphenyl tetracarboxylic dianhydride, and 3,3′,4,4′-benzophenone tetracarboxylic dianhydride, and particularly preferably 3,3′,4,4′-biphenyl tetracarboxylic dianhydride.

The tetracarboxylic dianhydride may be used alone or in combination of two or more thereof.

In addition, in a case of the combination of two or more thereof, each of an aromatic tetracarboxylic dianhydride or an aliphatic tetracarboxylic acid may be used in combination, or the aromatic tetracarboxylic dianhydride and the aliphatic tetracarboxylic dianhydride may be combined to be used.

Meanwhile, the diamine compound has two amino groups in a molecule structure. Examples of the diamine compound include any compound of aromatic and aliphatic compounds, but the aromatic compound is preferable. That is, in General Formula (I), the divalent organic group represented by B is not limited and is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl] propane, 2,2-bis[4-(4-aminophenoxy)phenyl] hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl] hexafluoropropane, and 4,4′-bis[4-(4-amino-2-trifluoromethyl)phenoxy]-octafluorobiphenyl; an aromatic diamine having two amino groups bonded to an aromatic ring such as diaminotetraphenylthiophene and a hetero atom other than the nitrogen atom of the amino group; aliphatic diamines and alicyclic diamines such as 1,1-meta-xylylene diamine, 1,3-propane diamine, tetramethylene diamine, pentamethylene diamine, octamethylene diamine, nonamethylene diamine, 4,4-diaminoheptamethylene diamine, 1,4-diaminocyclohexane, isophorone diamine, tetrahydrodicyclopentadienylenediamine, hexahydro-4,7-methanoindanylenedimethylene diamine, tricyclo[6,2,1,0^{2.7}]-undecylenedimethyldiamine, and 4,4′-methylenebis(cyclohexylamine); and the like.

Among these, as the diamine compound, the aromatic diamine compound is, for example, preferable, and specific examples thereof are more preferably p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenyl sulfone, and particularly preferably 4,4′-diaminodiphenyl ether and p-phenylenediamine.

The diamine compound may be used alone or in combination of two or more thereof. In addition, in a case of the combination of two or more thereof, each of the aromatic diamine compound and the aliphatic diamine compound may be used in combination, or the aromatic diamine compound and the aliphatic diamine compound may be combined to be used.

A number average molecular weight of the polyimide precursor is, for example, preferably 1000 or more and 150000 or less, more preferably 5000 or more and 130000 or less, and even more preferably 10000 or more and 100000 or less.

In a case where the number average molecular weight of the polyimide precursor is within the above range, a deterioration in the solubility of the polyimide precursor in the solvent is suppressed, and thus a film forming property is easily ensured.

The number average molecular weight of the polyimide precursor is measured by a gel permeation chromatography (GPC) method under following measurement conditions.
Column: TSKgel α-M of Tosoh Corporation (7.8 mm I.D×30 cm)
Eluent: DMF (dimethylformamide)/30 mM LiBr/60 mM phosphoric acid
Flow rate: 0.6 mL/min
Injection volume: 60 μL
Detector: RI (differential refractive index detector)

A content (concentration) of the polyimide precursor is, for example, preferably 0.1% by mass or more and 40% by mass or less, and more preferably 0.5% by mass or more and 25% by mass or less, and even more preferably 1% by mass or more and 20% by mass or less with respect to a total content of the polyimide precursor solution.

Organic Amine Compound

The organic amine compound is a compound which amine-salifies the polyimide precursor (a carboxy group thereof) to improve the solubility of the polyimide precursor in the aqueous solution, and which also function as an imidization promoter. Specifically, for example, the organic amine compound is preferably an amine compound having a molecular weight of 170 or less. The organic amine compound is not limited and is preferably a compound excluding a diamine compound which is a raw material of the polyimide precursor.

The organic amine compound is not limited and is preferably a water-soluble compound. The term “water-soluble” means that a target substance is dissolved by 1% by mass or more with respect to the water at 25° C.

Examples of the organic amine compound include a primary amine compound, a secondary amine compound, and a tertiary amine compound.

Among these, as the organic amine compound, at least one (particularly, tertiary amine compound) selected from the secondary amine compound and the tertiary amine compound is preferable although there is no particular limitation. In a case of applying the tertiary amine compound or the secondary amine compound as the organic amine compound (particularly, the tertiary amine compound), the solubility of the polyimide precursor in the solvent is easily improved, a film forming property is easily improved, and preservation stability of the polyimide precursor solution is easily improved.

In addition, examples of the organic amine compound include a divalent or higher polyvalent amine compound, in addition to a monovalent amine compound. In a case of applying the divalent or higher polyvalent amine compound, a pseudo-crosslinked structure between molecules of the polyimide precursor is easily formed, and the preservation stability of the polyimide precursor solution is easily improved.

Examples of the primary amine compound include methylamine, ethylamine, n-propylamine, isopropylamine, 2-ethanolamine, 2-amino-2-methyl-1-propanol, and the like.

Examples of the secondary amine compound include dimethylamine, 2-(methylamino) ethanol, 2-(ethylamino) ethanol, morpholine, and the like.

Examples of the tertiary amine compound include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, and the like.

From the viewpoints of a pot life of the polyimide precursor solution and film thickness evenness, for example, the tertiary amine compound is preferable. From the above viewpoints, at least one selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine is, for example, more preferable.

As the organic amine compound, from the viewpoint of the film forming property, for example, an amine compound having a nitrogen-containing heterocyclic structure (particularly, the tertiary amine compound) is also preferable. Examples of the amine compound having a nitrogen-containing heterocyclic structure (hereinafter will be referred to as “nitrogen-containing heterocyclic amine compound”) include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, polyamine, and the like.

As the nitrogen-containing heterocyclic amine compound, from the viewpoint of the film forming property, for example, at least one selected from the group consisting of morpholines, pyridines, piperidines, and imidazoles is preferable, and morpholines (amine compounds having a morpholine skeleton) is more preferable. Among these, for example, at least one selected from the group consisting of N-methylmorpholine, N-methylpiperidine, pyridine, 1,2-dimethylimidazole, 2-ethyl-4-methylimidazole, and picoline is more preferable, and N-methylmorpholine is even more preferable.

Among these, as the organic amine compound, for example, a compound having a boiling point of 60° C. or higher (preferably 60° C. or higher and 200° C. or lower, more preferably 70° C. or higher and 150° C. or lower) is preferable. In a case where the organic amine compound has the boiling point of 60° C. or higher, volatilization of the organic amine compound from the polyimide precursor solution when storing the compound is suppressed, and a deterioration in the solubility of the polyimide precursor in the solvent is easily suppressed.

A content of the organic amine compound is, for example, preferably 50 mol % or more and 500 mol % or less, more preferably 80 mol % or more and 250 mol % or less, and even more preferably 90 mol % or more and 200 mol % or less with respect to a carboxy group (—COOH) of the polyimide precursor in the polyimide precursor solution.

In a case where the content of the organic amine compound is within the above range, the solubility of the polyimide precursor in the solvent is easily improved, and thus the film forming property is easily improved. In addition, the preservation stability of the polyimide precursor solution is also easily improved.

The organic amine compound may be used alone or in combination of two or more thereof.

Other Additives

In the method for producing the polyimide precursor solution according to this exemplary embodiment, the polyimide precursor solution may contain a catalyst for accelerating imidization reaction, a leveling agent for improving a quality of a film to be formed, and the like.

As the catalyst for accelerating the imidization reaction, a dehydrating agent such as an acid anhydride, an acid catalyst such as a phenol derivative, a sulfonic acid derivative, and a benzoic acid derivative, or the like may be used.

In addition, according to a purpose of use, the polyimide precursor solution may contain, as a material other than the inorganic particles having the volume average particle diameter within a range of 0.001 μm to 0.2 μm, for example, a conductive material added for imparting conductivity (conductive (for example, volume resistivity of 10⁷ Ω·cm or less) or semiconductivity (for example, volume resistivity of 10⁷ Ω·cm or more and 10¹³ Ω·cm or less)).

Examples of a conductive agent include carbon black (for example, acidic carbon black having a pH of 5.0 or less); a metal (for example, aluminum, nickel, or the like); a metal oxide (for example, yttrium oxide, tin oxide, or the like); an ion conducting substance (for example, potassium titanate, LiCi, or the like); and the like. These conductive materials may be used alone or in combination of two or more kinds thereof.

In addition, according to a purpose of use, the polyimide precursor solution may contain inorganic particles having a volume average particle diameter of larger than 0.2 μm, which are added for improving mechanical strength. Examples of the inorganic particles include particulate materials such as silica powder, alumina powder, barium sulfate powder, titanium oxide powder, mica, and talc.

Next, the dispersibility of the polyimide precursor solution according to this exemplary embodiment will be described.

From the viewpoint of suppressing the generation of the pinholes, a volume-based particle size distribution of the resin particles in the polyimide precursor solution has at least one maximum value, and a percentage accounting for a volume frequency of particles having a particle diameter two or more times a particle diameter of a maximum value A in which a volume frequency becomes largest among maximum values, is preferably less, and is more preferably 5% or less with respect to the volume frequency of the maximum value A, although there is no particular limitation. In the same viewpoint, the percentage accounting for the volume frequency of the particles having the particle diameter two or more times the particle diameter of the maximum value A is, for example, preferably 4% or less, more preferably 3% or less, even more preferably 2% or less, and particularly preferably 0%. The particles having the particle diameter two or more times the particle diameter of the maximum value A mainly contain the resin particles, and may contain the inorganic particles.

In this specification, the term “volume frequency” indicates a presence ratio of the resin particles measured on a volume basis in the particle size distribution of the resin particles in the polyimide precursor solution.

The term “maximum value” (peak) represents a point which turns from an ascending direction to a descending direction, at an arc portion drawn by a curve repeating in a vertical direction of a distribution curve, when drawing the distribution curve of a volume frequency with respect to a divided particle size range (channel) based on the particle size distribution measured by a measurement method described later.

The particle size distribution of the particles in the polyimide precursor solution is measured as follows.

The polyimide precursor solution to be measured is diluted with water. Thereafter, the particle size distribution of the resin particles in the diluted polyimide precursor solution is measured by using COULTER COUNTER LS13 (manufactured by Beckman Coulter, Inc.). Based on the measured particle size distribution, the particle size distribution with respect to the divided particle size range (channel) is measured by drawing a volume cumulative distribution from a smaller particle diameter.

Then, a maximum value in which a volume frequency becomes largest among the volume cumulative distribution drawn from the smaller particle diameter, is obtained, and this maximum value is taken as the maximum value A. A percentage accounting for the volume frequency of the particles two or more times the maximum value A, is obtained.

In a case where the volume-based particle size distribution of the particle diameter of the particles including the resin particles in the polyimide precursor solution is unlikely to be measured by the above-described method, the volume-based particle size distribution is measured by a method such as a dynamic light scattering method.

Polyimide Film Containing Resin Particles and Inorganic Particles

The polyimide film containing the resin particles and the inorganic particles is obtained by applying the polyimide precursor solution according to this exemplary embodiment so as to form a coated film, and then heating the coated film.

The polyimide film containing the resin particles and the inorganic particles includes a polyimide film that contains the resin particles and the inorganic particles and that is partially imidized before completing of the imidization, in addition to a polyimide film that contains the resin particles and the inorganic particles and in which the imidization is completed.

Specifically, the method for producing the polyimide film containing the resin particles and the inorganic particles according to this exemplary embodiment includes, for example, a step of applying the polyimide precursor solution according to this exemplary embodiment to forma coated film (hereafter will be referred to as “coated film formation step”), and a step of heating the coated film to form the polyimide film (hereafter will be referred to as “heating step”).

Coated Film Formation Step

First, the above-described polyimide precursor solution in which the resin particles are dispersed (resin particle and inorganic particle-dispersed polyimide precursor solution) is prepared. Subsequently, the resin particle and inorganic particle-dispersed polyimide precursor solution is applied on the substrate, and therefore the coated film is formed.

Examples of the substrate include a substrate made of resin; a substrate made of glass; a substrate made of ceramic; a metal substrate; and a substrate of a composite material obtained by combining these materials. In a case of forming a continuous film, it is preferable to use the metal substrate, although there is no particular limitation. The substrate may have a peeling layer which has been subjected to a peeling process. Since the peelability, from substrate, of the porous polyimide film obtained by using the polyimide precursor solution according to this exemplary embodiment is improved, the peelability is excellent even in a case where the substrate is not subjected to the peeling process. Therefore, the peeling process may not be performed, and the peeling layer may not be provided.

In addition, a method for applying the resin particle and inorganic particle-dispersed polyimide precursor solution to the substrate is not particularly limited, and examples thereof include various methods such as a spray coating method, a spin coating method, a roll coating method, a bar coating method, a slit die coating method, and an ink jet coating method.

As the substrate, various substrates may be used according to a purpose of use. Examples thereof include various substrates applied to liquid crystal elements; a semiconductor substrate on which an integrated circuit is formed, a wiring substrate on which wiring is formed, and a substrate of a print substrate provided with electronic parts and wiring; a substrate for electric wire coating material; and the like.

Heating Step

Next, the coated film obtained in the coated film formation step is subjected to a drying process. In the drying process, a dried coated film is formed.

As a heating condition in the drying process, for example, heating at a temperature of 80° C. or higher and 200° C. or lower for 10 minutes or longer and 60 minutes or shorter, is preferable, and it is more preferable that a heating time becomes shorter as a temperature becomes higher. Applying hot air during the heating is also effective. When heating, the temperature may be raised step by step, or may be raised without changing a raising speed.

Next, the dried coated film before being subject to the imidization is heated, and the imidization process is performed. Therefore, a polyimide resin layer is formed.

As a heating condition in the imidization process, an imidization reaction is raised by heating at, for example, 150° C. or higher and 450° C. or lower (for example, preferably 200° C. or higher and 430° C. or lower) for 20 minutes or longer and 60 minutes or shorter, and therefore the polyimide film is formed. In a case of the heating reaction, before the temperature reaches a final temperature for the heating, the heating may be performed by raising the temperature step by step, or gradually raising the temperature at a certain speed.

Through the above-described steps, the polyimide film containing the resin particles and the inorganic particles is formed. Then, as necessary, the polyimide film containing the resin particles and the inorganic particles is taken out from the substrate, and the polyimide film containing the resin particles and the inorganic particles is obtained. In addition, the polyimide film containing the resin particles and the inorganic particles may be subjected to a post process according to a purpose of use.

Method for Producing Porous Polyimide Film

A method for producing the porous polyimide film according to this exemplary embodiment includes a first step of applying the polyimide precursor solution according to this exemplary embodiment to form a coated film, and then drying the coated film so as to form a dried coated film containing the polyimide precursor, the resin particles, and the inorganic particles; and a second step of heating the dried coated film and imidizing the polyimide precursor so as to form a polyimide film, the second step having a process of removing the resin particles.

Hereinafter, the method for producing the porous polyimide film according to this exemplary embodiment will be described.

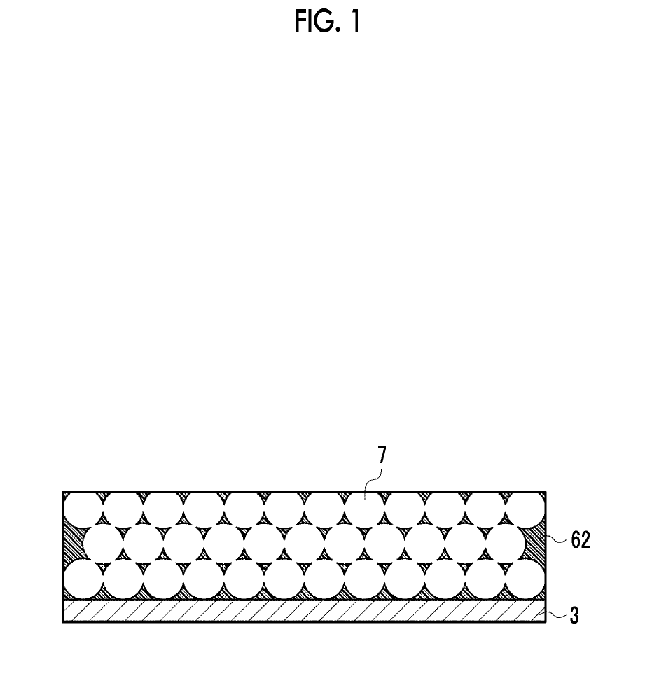

In the description of the producing method, as reference numerals of FIG. 1, a reference numeral 3 denotes a substrate, a reference numeral 7 denotes a pore, and a reference numeral 62 denotes a porous polyimide film.

First Step

In a first step, first, the polyimide precursor solution containing the aqueous solution, the resin particles, and the inorganic particles having the volume average particle diameter within a range of 0.001 μm to 0.2 μm (resin particle and inorganic particle-dispersed polyimide precursor solution) is prepared. Subsequently, the resin particle and inorganic particle-dispersed polyimide precursor solution is applied to the substrate, and therefore the coated film containing the polyimide precursor solution, the resin particles, and the inorganic particles is formed. Then, the coated film formed on the substrate dried, and therefore the dried coated film containing the polyimide precursor, the resin particles, and the inorganic particles is formed.

In the first step, examples of a method for forming, on the substrate, the coated film containing the polyimide precursor, the resin particles, and the inorganic particles include a method as follows, but the method is not limited to the following method.

Specifically, first, the dispersion in which the resin particles and the inorganic particles are dispersed in the aqueous solution is prepared. Then, the organic amine compound, the tetracarboxylic dianhydride, and the diamine compound are mixed in this dispersion, the tetracarboxylic dianhydride and the diamine compound are polymerized, and therefore the polyimide precursor is formed. Subsequently, this resin particle and inorganic particle-dispersed polyimide precursor solution is applied to the substrate, and therefore the coated film containing the polyimide precursor solution, the resin particles, and the inorganic particles is formed. The resin particles and the inorganic particles in this coated film are distributed in a state in which aggregation is suppressed.

The substrate to which the resin particle and inorganic particle-dispersed polyimide precursor solution is applied is not particularly limited. Examples thereof include a metal substrate such as aluminum or stainless steel (SUS), a composite material substrate combined with a material other than metal, and the like. In addition, as necessary, the substrate may have a peeling layer subjected to the peeling process by, for example, a silicone-based or fluorine-based peeling agent or the like. Since the peelability, from substrate, of the porous polyimide film obtained by using the polyimide precursor solution according to this exemplary embodiment is improved, the peelability is excellent even in a case where the substrate is not subjected to the peeling process. Therefore, the peeling process may not be performed, and the peeling layer may not be provided.

A method for applying, to the substrate, the resin particle and inorganic particle-dispersed polyimide precursor solution is not particularly limited. Examples thereof include various methods such as a spray coating method, a spin coating method, a roll coating method, a bar coating method, a slit die coating method, and an ink jet coating method.

An amount to be applied of the polyimide precursor solution for obtaining the coated film containing the polyimide precursor solution, the resin particles, and the inorganic particles may be set to an amount by which a predetermined film thickness is obtained.

The coated film containing the polyimide precursor solution, the resin particles, and the inorganic particles is formed and then dried, and therefore the dried coated film containing the polyimide precursor, the resin particles, and the inorganic particles is formed. Specifically, the coated film containing the polyimide precursor solution, the resin particles, and the inorganic particles is dried by a method such as heat drying, natural drying, and vacuum drying, and therefore the dried coated film is formed. More specifically, the coated film is dried such that a content of the solvent remaining in the coat film becomes 50% or less, and becomes, for example, preferably 30% or less with respect to a solid content of the coat film, and therefore the dried coated film is formed. The dried coated film is in a state where the polyimide precursor may be dissolved in water.

Second Step

A second step is a step of heating the coat containing the polyimide precursor, the resin particles, and the inorganic particles, which is obtained in the first step, imidizing the polyimide precursor so as to form the polyimide film. Then, the second step includes the process for removing the resin particles. Through the process for removing the resin particles, the porous polyimide film is obtained.

In the second step, in the step of forming the polyimide film, specifically, the dried coated film containing the polyimide precursor, the resin particles, and the inorganic particles, which is obtained in the first step is heated, the imidization is allowed to proceed, and by further heating, the polyimide film is formed. As the imidization proceeds and an imidization ratio becomes higher, the polyimide precursor becomes unlikely to be dissolved in the organic solvent.

Then, in the second step, the process of removing the resin particles is performed. The resin particles may be removed during the process of imidizing the polyimide precursor by heating the dried coated film, or may be removed from the polyimide film in which the imidization is completed (after the imidization).

In this exemplary embodiment, the process of imidizing the polyimide precursor refers to a process in which the dried coated film containing the polyimide precursor and the resin particles, which is obtained in the first step is heated, the imidization is allowed to proceed, and the polyimide film becomes in a state before completing the imidization.

The process of removing the resin particles is, for example, preferably carried out when an imidization ratio of the polyimide precursor in the polyimide film becomes 10% or more in the process of imidizing the polyimide precursor, from the viewpoint of removing performance of the resin particles and the like. In the case where the imidization ratio becomes 10% or more, the polyimide precursor easily becomes in the state of being unlikely to be dissolved in the organic solvent, and therefore a form of the film is easily maintained.

Examples of the process of removing the resin particles include a method of removing the resin particles by heating, a method of removing the resin particles by the organic solvent in which the resin particles are dissolved, a method of removing the resin particles by decomposition by a laser and the like, and the like. Among these, for example, the method of removing the resin particles by heating and the method of removing the resin particles by the organic solvent in which the resin particles are dissolved are preferable.

In the method of removing the resin particles by heating, for example, in the process of imidizing the polyimide precursor, the resin particles may be removed by decomposition by heating which is for allowing the imidization to proceed. This case is, although there is no particular limitation, preferable for reducing the steps from the viewpoint that there is no operation for removing the resin particles with the solvent. Meanwhile, depending on types of the resin particles, decomposed gas by heating may be generated in some cases. Due to the decomposed gas, breakage, cracking, or the like may occur in the porous polyimide film in some cases. Therefore, in this case, for example, it is preferable to adopt the method of removing the resin particles by the organic solvent in which the resin particles are dissolved.

Examples of the method of removing the resin particles by the organic solvent in which the resin particles are dissolved include a method in which the resin particles come into contact with the organic solvent in which the resin particles are dissolved (for example, immersed into the solvent), the resin particles are dissolved, and thus are removed. In this state, the case in which the resin particles are immersed into the solvent is, for example, preferable from the viewpoint of increasing a dissolution efficiency of the resin particles.

The organic solvent for dissolving the resin particles, which is for removing the resin particles is not particularly limited as long as the organic solvent is an organic solvent in which the resin particles are soluble without dissolving the polyimide film and the polyimide film in which the imidization is completed. Examples thereof include ethers such as tetrahydrofuran; aromatics such as toluene; ketones such as acetone; and esters such as ethyl acetate.

In the second step, a heating method for heating the dried coated film obtained in the first step and allowing the imidization to proceed so as to obtain the polyimide film, is not particularly limited. Examples thereof include a method in which the heating is performed in two steps. In the case of the heating in two steps, specifically, there are heating conditions as below.

A heating condition of a first step is, for example, preferably a temperature at which a shape of the resin particles is retained. Specifically, for example, the temperature is preferably within a range of 50° C. to 150° C., and is more preferably within a range of 60° C. to 140° C. In addition, a heating time is not limited and is preferably within a range of 10 minutes to 60 minutes. For example, it is preferable that the heating time becomes shorter as the heating temperature becomes higher.

As a heating condition of a second step, heating is performed under conditions of, for example, at 150° C. or higher and 450° C. or lower (preferably 200° C. or higher and 430° C. or lower) for 20 minutes or longer and 120 minutes or shorter. By setting the heating condition within this range, the imidization reaction further proceeds, and therefore the polyimide film may be formed. In a case of the heating reaction, for example, it is preferably that before the temperature reaches a final temperature for the heating, the heating is performed by raising the temperature step by step, or gradually raising the temperature at a certain speed.

The heating condition is not limited to the heating method of two steps as described above, and for example, a method of heating by one step may be adopted. In the case of the method of heating by the first step, for example, the imidization may be completed only by the heating condition shown in the second step.

In the second step, from the viewpoint of increasing a rate of hole area, for example, it is preferable to perform a process of exposing the resin particles so that the resin particles become in a state of being exposed. In the second step, the process of exposing the resin particles is, for example, preferably carried out during the process of imidizing the polyimide precursor or after the imidization, and before the process of removing the resin particles.

In this case, for example, in the case of forming the coat on the substrate using the resin particle and inorganic particle-dispersed polyimide precursor solution, the resin particle and inorganic particle-dispersed polyimide precursor solution are applied to the substrate, and therefore the coated film in which the resin particles are embedded is formed. Next, the coated film is dried, and thus the coat containing the polyimide precursor and the resin particles is formed. The coat formed by this method is in a state in which the resin particles are embedded. Before heating and performing the process of removing the resin particles from the coat, the process of exposing the resin particles from the polyimide film which is in the process of imidizing the polyimide precursor, or in which the imidization has been completed (after the imidization), may be performed.

In the second step, the process of exposing the resin particles may be performed, for example, when the polyimide film becomes in the following state.

In a case where the process of exposing the resin particles is performed when the imidization ratio of the polyimide precursor in the polyimide film is less than 10% (that is, a state in which the polyimide film may be dissolved in water), examples of the process of exposing the resin particles embedded in the polyimide film include a wiping process, a process of immersing into water, and the like.

In addition, in a case where the process of exposing the resin particles is performed when the imidization ratio of the polyimide precursor in the polyimide film is 10% or more (that is, a state in which the polyimide film is unlikely to be dissolved in water and the organic solvent) and when the polyimide film in which the imidization has been completed is obtained, there are a method of mechanically cutting the resin particles with a tool such as sandpaper to expose the resin particles, and a method of exposing the resin particles by decomposing with a laser and the like.

For example, in the case of the mechanical cutting, a part of the resin particles present in an upper region of the resin particles embedded in the polyimide film (that is, a region of the resin particles on a side away from the substrate) is cut together with the polyimide film present on the upper part of the resin particles, and the cut resin particles are exposed from the surface of the polyimide film.

Thereafter, from the polyimide film from which the resin particles are exposed, the resin particles are removed by the above-described process of removing the resin particles. Therefore, the porous polyimide film from which resin particles are removed is obtained (refer to FIG. 1).

In the above description, in the second step, the process of producing the porous polyimide film subjected to the process of exposing the resin particles has been described, but from the viewpoint of increasing the rate of hole area, the resin particles may be subjected to the process exposing the resin particles in the first step. In this case, in the first step, the resin particles may become in the state of being exposed by performing the process of exposing the resin particles in the process of obtaining the coated film, drying the film, and thereby forming the dried coated film. By performing the process of exposing the resin particles, the rate of hole area of the porous polyimide film is increased.

For example, in the process of obtaining the coated film containing the polyimide precursor solution, the resin particles, and the inorganic particles, and then drying the coated film to form the dried coated film containing the polyimide precursor, the resin particles, and the inorganic particles, as described above, the dried coated film becomes in a state in which the polyimide precursor is soluble in water. When the dried coated film is in this state, the resin particles may be exposed by, for example, the wiping process, the process of immersing into water, and the like. Specifically, by performing the process of exposing the resin particle layer by, for example, water-wiping the polyimide precursor solution present in a region with a thickness equal to or thicker than a thickness of the resin particle layer, the polyimide precursor solution present in the region with the thickness equal to or thicker than the thickness of the resin particle layer is removed. Then, the resin particles present in a region above the resin particle layer (that is, a region of the resin particle layer on a side away from the substrate) are exposed from the surface of the coat.

In a case where, for example, it is preferable to provide a skin layer which does not have holes on a surface thereof similarly to a gas separation film, it is preferable that the process of exposing the resin particles is not performed.

In the second step, the substrate for forming the coated film used in the first step may be peeled off when the coated film is dried, may be peeled off when the polyimide precursor in the polyimide film becomes in the state of being unlikely to be dissolved in the organic solvent, or may be peeled off when the film is in a state where the imidization has been completed.

Through the above-described steps, the porous polyimide film is obtained. The porous polyimide film may be post-processed depending on a purpose of use.

The imidization ratio of the polyimide precursor will be described.

Examples of the partially imidized polyimide precursor include a precursor of a structure having a repeating unit represented by General Formula (I-1), General Formula (I-2), and General Formula (I-3).

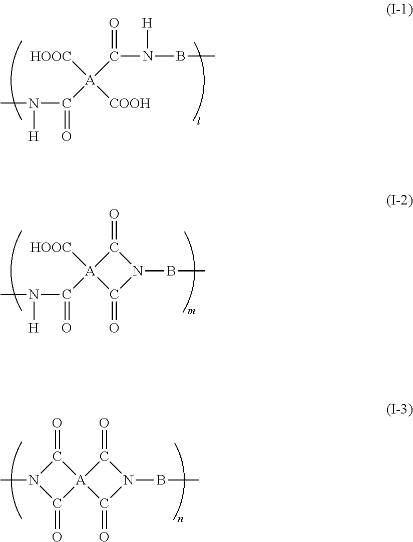

In General Formulas (I-1), (I-2), and (I-3), A represents a tetravalent organic group, and B represents a divalent organic group. 1 represents an integer of 1 or more, and m and n each independently represent an integer of 0 or 1 or more.

A and B are the same as A and B in General Formula (I).

The imidization ratio of the polyimide precursor represents a rate of the number of bonding parts (2n+m) with imide ring closure to a total number of bonding parts (2l+2m+2n) in a bonding part of the polyimide precursor (a reaction part of the tetracarboxylic dianhydride and the diamine compound). That is, the imidization ratio of the polyimide precursor is represented by “(2n+m)/(2l+2m+2n).”

The imidization ratio (value of “(2n+m)/(2l+2m+2n)”) of the polyimide precursor is measured by the following method.

Measurement of Imidization Ratio of Polyimide Precursor

Production of Polyimide Precursor Sample

(i) A coated film sample is produced by applying a polyimide precursor composition to be measured on a silicon wafer in a film thickness range of 1 μm to 10 μm.

(ii) The coated film sample is immersed into tetrahydrofuran (THF) for 20 minutes and the solvent in the coated film sample is replaced with tetrahydrofuran (THF). The solvent into which the film is to be immersed is not limited to THF, and the solvent may be selected from a solvent by which the polyimide precursor does not dissolve, and which is miscible with solvent components contained in the polyimide precursor composition. Specifically, alcohol solvents such as methanol and ethanol, and ether compounds such as dioxane may be used.

(iii) The coated film sample is taken out from the THF, and N2 gas is blown to the THF adhering to a surface of the coated film sample, and therefore THF is removed. The coated film sample is dried by being processed for 12 hours or longer under reduced pressure of 10 mmHg or less and within a range of 5° C. to 25° C., and therefore a polyimide precursor sample is produced.

Production of 100%-Imidized Standard Sample

(iv) In the same manner as in (i), a polyimide precursor composition to be measured is applied on a silicon wafer, and therefore a coated film sample is produced.

(v) The coated film sample is heated at 380° C. for 60 minutes to perform the imidization reaction, and therefore a 100%-imidized standard sample is produced.

Measurement and Analysis

(vi) Infrared absorption spectrum of the 100%-imidized standard sample and the polyimide precursor sample is measured by using a Fourier transform infrared spectrophotometer (FT-730 manufactured by HORIBA, Ltd.). A ratio I′ (100) of an imide bond-derived absorption peak near 1780 cm⁻¹ (Ab′ (1780 cm⁻¹)) to an aromatic ring-derived absorption peak near 1500 cm⁻¹ (Ab′ (1500 cm⁻¹)) of the 100%-imidized standard sample is obtained.

(vii) In the same manner, the measurement is performed on the polyimide precursor sample, and a ratio I (x) of an imide bond-derived absorption peak near 1780 cm⁻¹ (Ab′ (1780 cm⁻¹)) to an aromatic ring-derived absorption peak near 1500 cm⁻¹ (Ab′(1500 cm⁻¹)) of the 100%-imidized standard sample is obtained.

Then, using each measured light absorption peak I′ (100), I(x), the imidization ratio of the polyimide precursor is calculated based on the following formula.

imidization ratio of polyimide precursor=I(x)/I′(100) Formula:

I′(100)=(Ab′(1780 cm⁻¹))/(Ab′(1500 cm⁻¹)) Formula:

I(x)=(Ab(1780 cm⁻¹))/(Ab(1500 cm⁻¹)) Formula:

This measurement of the imidization ratio of the polyimide precursor is applied to a measurement of the imidization ratio of an aromatic polyimide precursor. In a case of measuring the imidization ratio of the aliphatic polyimide precursor, a peak derived from a structure which does not change before and after the imidization reaction is used as an internal standard peak, instead of the absorption peak of the aromatic ring.

Porous Polyimide Film

Hereinafter, the porous polyimide film of this exemplary embodiment will be described.

The porous polyimide film according to this exemplary embodiment includes spherical pores in which an average value of a pore diameter is 1.0 μm or smaller, and includes the inorganic particles that have the volume average particle diameter within a range of 0.001 μm to 0.2 μm. In addition, the porous polyimide film includes the spherical pores in which the average value of the pore diameter is 1.0 μm or smaller, and includes the inorganic particles that have the volume average particle diameter within a range of 0.001 μm to 0.2 μm, in which the air infiltration rate is 10 seconds or longer and 30 seconds and shorter. The porous polyimide film according to this exemplary embodiment has the above-described configuration, and therefore the generation of the pinholes is suppressed, and the peelability from the substrate is improved.

In the porous polyimide film according to this exemplary embodiment, the content of the inorganic particles having the volume average particle diameter within a range of 0.001 μm to 0.2 μm is, for example, preferably 3% by mass or more and 50% by mass or less, and more preferably 5% by mass or more and 30% by mass or less with respect to an entire porous polyimide film. For example, the content of the inorganic particles in the porous polyimide film may be 10% by mass or more and 25% by mass or less.

Characteristics of Porous Polyimide Film

The porous polyimide film according to this exemplary embodiment is not particularly limited, but preferably has porosity of 30% or more. In addition, the porosity is, for example, preferably 40% or more, and more preferably 50% or more. An upper limit of the porosity is not particularly limited, but is preferably within a range of 90% or less.

The pore has spherical shape. The spherical shape is spherical or a shape close to a spherical shape. In this specification, the term “spherical” in the pore includes both a spherical shape and a nearly spherical shape (a shape close to a spherical shape). Specifically, the spherical shape means that a proportion of particles having a ratio of a major axis to a minor axis (major axis/minor axis) of 1 or more and 1.5 or less is 90% or more. As the ratio of the major axis to the minor axis approaches 1, the shape becomes closer to a spherical shape.

In addition, for example, it is preferable that the pores have a shape in which the pores are connected to each other to be continuous (refer to FIG. 1). A pore diameter of a portion where the pores are connected to each other is, for example, preferably 1/100 or more and ½ or less, more preferably 1/50 or more and ⅓ or less, and even more preferably 1/20 or more and ¼ or less with respect to a maximum diameter of the pore. Specifically, for example, it is preferable that an average value of the pore diameters of portions where the pores are connected to each other to be continuous is 5 nm or more and 1500 nm or less.

The average value of the pore diameters is not particularly limited, but is, for example, preferably 0.1 μm or more and 1.0 μm or less, more preferably 0.25 μm or more and 0.98 μm or less, and even more preferably 0.25 μm or more and 0.95 μm or less.

In the porous polyimide film of this exemplary embodiment, a ratio of a maximum diameter to a minimum diameter of the pores (ratio of a maximum value to a minimum value of the pore diameter) is 1 or more and 2 or less. The ratio is, for example, preferably 1 or more and 1.9 or less, and more preferably 1 or more and 1.8 or less. Among these ranges, for example, the range that is closer to 1 is even more preferable. By setting the range within this range, variations in the pore diameter are suppressed. In addition, in a case where the porous polyimide film of this exemplary embodiment is applied to, for example, a battery separator of a lithium ion battery, disturbance in an ion flow is suppressed, and thus formation of lithium dendrite is easily suppressed. The term “ratio of the maximum diameter to the minimum diameter of the pores” is a ratio expressed by a value obtained by dividing the maximum diameter by the minimum diameter of the pores (that is, the maximum value/the minimum value of the pore diameters).

The average value of the pore diameters and the average value of the pore diameters of the portions where the pores are connected to each other are the values observed and measured with a scanning electron microscope (SEM). Specifically, first, the porous polyimide film is cut out, and a sample for measurement is prepared. Then, this sample for measurement is observed and measured by VE SEM manufactured by KEYENCE CORPORATION with generally installed image processing software. The observation and measurement are performed 100 times on each of pore portion in a cross section of the sample for measurement, and an average value, a minimum diameter, a maximum diameter, and an arithmetic mean diameter of each pore portion are obtained. In a case where the shape of the pore is not circular, a longest portion is taken as a diameter.

In the porous polyimide film according to this exemplary embodiment, for example, it is preferable that an air infiltration rate is 10 seconds or longer and 30 seconds or shorter. A lower limit of the air infiltration rate may be 12 seconds or longer, or may be 15 seconds or longer. In addition, for example, an upper limit of the air infiltration rate may be 28 seconds or shorter, and may be 25 seconds or shorter. A method for measuring the air infiltration rate will be described in examples below.

A film thickness of the porous polyimide film is not particularly limited, but is preferably 15 μm or more and 500 μm or less, for example.

Application of Porous Polyimide Film

Examples of usage to which the porous polyimide film according to this exemplary embodiment is applied include battery separators such as lithium batteries; separators for electrolytic capacitors; electrolyte films such as fuel cells; battery electrode materials; separation film of gases or liquids; low dielectric constant materials; filtration films; and the like.

In a case where the porous polyimide film according to this exemplary embodiment is applied to, for example, a battery separator, it is considered that generation of lithium dendrite is suppressed by an effect such as suppression of variations in ion current distribution of lithium ions. It is presumed that the reason for this is because the variations in the pore shape and the pore diameter of the porous polyimide film of this exemplary embodiment are suppressed.

In addition, for example, in a case where the porous polyimide film is applied to a battery electrode material, it is considered that chances of contacting with an electrolytic solution increase, and thus a capacity of the battery increases. It is presumed that the reason for this is because an amount of a material such as carbon black for electrodes, which is to be contained in the porous polyimide film, exposed on the surface of the pore diameter of the porous polyimide film or on the surface of the film, increases.

Furthermore, for example, the porous polyimide film may also be applicable as an electrolyte film by filling the pores of the porous polyimide film with, for example, a so-called ionic gel obtained by gelling an ionic liquid, and the like. Since the steps are simplified by the producing method of this exemplary embodiment, it is considered that a low-cost electrolyte film may be obtained.

### EXAMPLES

Examples will be described below, but the present invention is not limited to these examples. In the following description, “parts” and “%” are all based on mass unless otherwise specified.

Preparation of Inorganic Particle Dispersion

As the inorganic particle dispersion, the following silica particle dispersions are prepared.

Silica particle dispersion (1): volume particle diameter of 5 nm, solid content of 20% by mass

Silica particle dispersion (2): volume particle diameter of 13 nm, solid content of 30% by mass

Silica particle dispersion (3): volume particle diameter of 65 nm, solid content of 40% by mass

Silica particle dispersion (4): volume particle diameter of 210 nm, solid content of 40% by mass

Silica particle dispersion (5): volume particle diameter of 450 nm, solid content of 40% by mass

Silica particle dispersion (6): volume particle diameter of 150 nm, solid content of 40% by mass

Titanium oxide particle dispersion (7): volume particle diameter of 180 nm, solid content of 40% by mass

The average particle diameter of the inorganic particles is the volume average particle diameter measured by the method described above.

Preparation of Resin Particle Dispersion

Preparation of Resin Particle Dispersion 1

770 parts by mass of styrene, 230 parts by mass of butyl acrylate, 20 parts by mass of acrylic acid, 25.0 parts by mass of a surfactant, DOWFAX 2A1 (47% solution, manufactured by Dow Chemical Company), and 576 parts by mass of ion exchange water are mixed and stirred with a dissolver at 1500 rpm for 30 minutes, followed by emulsification, and therefore a monomer emulsion is prepared. Subsequently, 1.10 parts by mass of DOWFAX 2A1 (47% solution, manufactured by Dow Chemical Company) and 1270 parts by mass of ion exchange water are put into a reaction vessel. After heating to 75° C. in a nitrogen stream, 75 parts by mass of the monomer emulsion is added thereto. Thereafter, a polymerization initiator solution prepared by dissolving 15 parts by mass of ammonium persulfate in 98 parts by mass of ion exchange water is added dropwise over 10 minutes. After the dropwise addition, the reaction is allowed to proceed for 50 minutes, and then the remaining monomer emulsion is added dropwise over 220 minutes, reacted for further 180 minutes, and cools, and therefore a resin particle dispersion (1) which is a dispersion of styrene-acrylic resin particles having an acidic group on the surface thereof is obtained. A concentration of solid contents of the resin particle dispersion (1) is 34.4% by mass. In addition, an average particle diameter of this resin particles is 0.39 μm. The average particle diameter of the resin particles is the volume average particle diameter measured by the above-described method (the same applies hereinafter). The results are collectively shown in Table 1.

Preparation of Resin Particle Dispersion 2

770 parts by mass of styrene, 230 parts by mass of butyl acrylate, 5.0 parts by mass of a surfactant, DOWFAX 2A1 (47% solution, manufactured by Dow Chemical Company), and 576 parts by mass of ion exchange water are mixed and stirred with a dissolver at 1500 rpm for 30 minutes, followed by emulsification, and therefore a monomer emulsion is prepared. Subsequently, 1270 parts by mass of ion exchange water is put into a reaction vessel. After heating to 75° C. in a nitrogen stream, 25 parts by mass of the monomer emulsion is added thereto. Thereafter, a polymerization initiator solution prepared by dissolving 15 parts by mass of ammonium persulfate in 98 parts by mass of ion exchange water is added dropwise over 10 minutes. After the dropwise addition, the reaction is allowed to proceed for 50 minutes, and then the remaining monomer emulsion is added dropwise over 220 minutes and reacts for further 50 minutes. Subsequently, a solution in which 5 parts by mass of maleic acid and 10 parts by mass of ion exchange water are mixed is added dropwise over 5 minutes, the reaction is allowed to proceed for 150 minutes, followed by cooling, and therefore a resin particle dispersion (2) which is a dispersion of styrene-acrylic resin particles having an acidic group on the surface thereof is obtained. A concentration of solid contents of the resin particle dispersion (2) is 34.0% by mass. In addition, an average particle diameter of this resin particles is 0.80 μm. The results are collectively shown in Table 1.

Preparation of Resin Particle Dispersion 3

770 parts by mass of styrene, 230 parts by mass of butyl acrylate, 3.0 parts by mass of a surfactant, DOWFAX 2A1 (47% solution, manufactured by Dow Chemical Company), and 576 parts by mass of ion exchange water are mixed and stirred with a dissolver at 1500 rpm for 30 minutes, followed by emulsification, and therefore a monomer emulsion is prepared. Subsequently, 1270 parts by mass of ion exchange water is put into a reaction vessel. After heating to 75° C. in a nitrogen stream, 15 parts by mass of the monomer emulsion is added thereto. Thereafter, a polymerization initiator solution prepared by dissolving 15 parts by mass of ammonium persulfate in 98 parts by mass of ion exchange water is added dropwise over 10 minutes. After the dropwise addition, the reaction is allowed to proceed for 50 minutes, and then the remaining monomer emulsion is added dropwise over 220 minutes and reacted for further 50 minutes. Subsequently, a solution in which 5 parts by mass of maleic acid and 10 parts by mass of ion exchange water are mixed is added dropwise over 5 minutes, the reaction is allowed to proceed for 150 minutes, followed by cooling, and therefore a resin particle dispersion (3) which is a dispersion of styrene-acrylic resin particles having an acidic group on the surface thereof is obtained. A concentration of solid contents of the resin particle dispersion (3) is 34.0% by mass. In addition, an average particle diameter of this resin particles is 1.15 μm. The results are collectively shown in Table 1. In the resin particle dispersion (3), adherence (precipitation) of about 3 parts by mass of resin to a stirring blade is observed.

Preparation of Comparative Resin Particle Dispersion 4

A resin particle dispersion (4) is produced in the same manner as the resin particle dispersion (1) except that 20 parts by mass of acrylic acid is not used. The results are collectively shown in Table 1.

TABLE 1

| | | | | | Not having |
|---|---|---|---|---|---|
| | | Having acidic group on surface | | | acidic group |
| | | Acidic | Acidic | | on surface |
| | | monomer | monomer added | | No acidic |
| | | mixed | after reaction | | monomer |
| Resin particle | | 1 | 2 | 3 | 4 |
| dispersion No. | | | | | |
| Monomer | St | 770 | 770 | 770 | 770 |
| compositions | BA | 230 | 230 | 230 | 230 |
| (parts by | AA | 20 | | | |
| mass) | MA | | 5 | 5 | |

| | | | | |
|---|---|---|---|---|
| Precipitated resin | None | None | About 3 | None |
| content (parts by mass) | | | | |
| Solid content (% by | 34.4 | 34.0 | 34.0 | 34.0 |
| mass) | | | | |
| Volume average particle | 0.39 | 0.80 | 1.15 | 0.40 |
| diameter (μm) | | | | |

Details of abbreviations in Table 1 are shown below.
“St”: styrene
“BA”: butyl acrylate
“AA”: acrylic acid
“MA”: maleic acid

### Example 1

Production of Resin Particle and Inorganic Particle-Dispersed Polyimide Precursor Solution PAA-1

Resin particle dispersion (1): 209 g of ion exchange water is added to 100 g of resin particles (containing 191 g of water) expressed in terms of solid contents, and the concentration of solid contents of the resin particles is adjusted to 20% by mass. To the resin particle dispersion, the silica particle dispersion (1) is added so as to become 2 g expressed in terms of solid contents and mixed, and then 9.59 g (88.7 mmol) of p-phenylenediamine (molecular weight of 108.14) and 25.58 g (86.9 mmol) of 3,3′,4,4′-biphenyl tetracarboxylic dianhydride (molecular weight of 294.22) are added thereto, stirred at 20° C. for 10 minutes, and dispersed. Subsequently, 25.0 g (247.3 mmol) of N-methylmorpholine (organic amine compound) is slowly added and dissolved by stirring for 24 hours while maintaining a reaction temperature at 60° C. so as to allow the reaction, and then 25.0 g of N-methylpyrrolidone is further added and sufficiently stirred, and therefore a resin particle and inorganic particle-dispersed polyimide precursor solution (PAA-1) (corresponding to resin particle/polyimide precursor 100/35.2 (mass ratio), inorganic particle (silica particle)/polyimide precursor=2/35.2 (mass ratio), a silica concentration in the film of 5.6% when made into a porous polyimide film) is obtained. When the obtained PAA-1 is diluted with water and a particle size distribution is measured according to the method described above, similarly to the resin particle dispersion (1), particles including the resin particles having a particle diameter two or more times a particle diameter of the maximum value A are not observed, which is a favorable dispersion state.

### Examples 2 to 18

Resin particle and inorganic particle-dispersed polyimide precursor solutions (PAA-2) to (PAA-18) are obtained in the same manner as in Example 1 except that a type and an amount of the resin particle dispersion and a type and an amount of the silica particle dispersion are changed according to Table 2. A particle size distribution of the resin particle and inorganic particle-dispersed polyimide precursor solution of each example is measured by the method described above. The results are collectively shown in Table 2.

### Comparative Examples 1 to 5

Production of Resin Particle and Inorganic Particle-Dispersed Polyimide Precursor Solutions (PAA-R1 to PAA-R5)

Resin particle and inorganic particle-dispersed polyimide precursor solutions (PAA-R1) to (PAA-R5) are obtained in the same manner as in Example 1 except that the type and the amount of the resin particle dispersion and the type and the amount of the silica particle dispersion are changed according to Table 2. A particle size distribution of the resin particle and inorganic particle-dispersed polyimide precursor solution of each example is measured by the method described above. The results are collectively shown in Table 2.

TABLE 2

| | | | | Inorganic | | | | | Percentage of particles having |
|---|---|---|---|---|---|---|---|---|---|
| | | Resin particle | | particle | | | | Content of | particle diameter two or |
| | | dispersion | | dispersion | | Resin | Inorganic | inorganic | more times particle diameter |
| | | | Particle | | Particle | particle/polyimide | particle/polyimide | particles in | of maximum value A in |
| | PI precursor | | diameter | | diameter | precursor solution | precursor solution | film | polyimide precursor solution |
| | solution | No. | (μm) | No. | (nm) | (mass ratio) | (mass ratio) | (% by mass) | (%) |
| Example 1 | PAA-1 | 1 | 0.39 | 1 | 5 | 100/35.2 | 2/35.2 | 5.6 | 0 |
| Example 2 | PAA-2 | 1 | 0.39 | 1 | 5 | 100/35.2 | 4/35.2 | 10.6 | 0 |
| Example 3 | PAA-3 | 1 | 0.39 | 1 | 5 | 100/35.2 | 8/35.2 | 19.2 | 1.5 |
| Example 4 | PAA-4 | 1 | 0.39 | 1 | 5 | 100/35.2 | 13/35.2 | 27.9 | 2.5 |
| Example 5 | PAA-5 | 1 | 0.39 | 2 | 13 | 100/35.2 | 2/35.2 | 5.6 | 0 |
| Example 6 | PAA-6 | 1 | 0.39 | 3 | 65 | 100/35.2 | 2/35.2 | 5.6 | 0.5 |
| Example 7 | PAA-7 | 1 | 0.39 | 3 | 65 | 100/35.2 | 4/35.2 | 10.6 | 1.5 |
| Example 8 | PAA-8 | 2 | 0.80 | 1 | 5 | 100/35.2 | 2/35.2 | 5.6 | 0 |
| Example 9 | PAA-9 | 2 | 0.80 | 2 | 13 | 100/35.2 | 4/35.2 | 10.6 | 1.5 |
| Example 10 | PAA-10 | 2 | 0.80 | 3 | 65 | 100/35.2 | 8/35.2 | 19.2 | 3 |
| Example 11 | PAA-11 | 3 | 1.15 | 1 | 5 | 100/35.2 | 2/35.2 | 5.6 | 1 |
| Example 12 | PAA-12 | 3 | 1.15 | 2 | 13 | 100/35.2 | 2/35.2 | 5.6 | 1.5 |
| Example 13 | PAA-13 | 3 | 1.15 | 3 | 65 | 100/35.2 | 2/35.2 | 5.6 | 3.5 |
| Example 14 | PAA-14 | 1 | 0.39 | 1 | 5 | 100/35.2 | 18/35.2 | 34.9 | 1.5 |
| Example 15 | PAA-15 | 1 | 0.39 | 1 | 5 | 100/35.2 | 1/35.2 | 2.9 | 0 |
| Example 16 | PAA-16 | 1 | 0.39 | 1 | 5 | 100/35.2 | 1/35.2 | 2.9 | 2 |
| Example 17 | PAA-17 | 1 | 0.39 | 6 | 150 | 100/35.2 | 1/35.2 | 2.9 | 0 |
| Example 18 | PAA-18 | 1 | 0.39 | 7 | 180 | 100/35.2 | 1/35.2 | 2.9 | 1 |
| Comparative | PAA-R1 | 1 | 0.39 | — | — | 100/35.2 | — | — | 0 |
| Example 1 | | | | | | | | | |
| Comparative | PAA-R2 | 1 | 0.39 | 4 | 210 | 100/35.2 | 2/35.2 | 5.6 | 7.6 |
| Example 2 | | | | | | | | | |
| Comparative | PAA-R3 | 2 | 0.80 | 4 | 210 | 100/35.2 | 2/35.2 | 5.6 | 13.5 |
| Example 3 | | | | | | | | | |
| Comparative | PAA-R4 | 3 | 1.15 | 5 | 450 | 100/35.2 | 2/35.2 | 5.6 | 14 |
| Example 4 | | | | | | | | | |
| Comparative | PAA-R5 | 4 | 0.40 | 4 | 210 | 100/35.2 | 2/35.2 | 5.6 | 25 |
| Example 5 | | | | | | | | | |

In Table 2, the term “particle diameter” represents a volume average particle diameter.

In Table 2 and Table 3 to be described later, the term “PI” represents polyimide.

### Example 19

Production of Porous Polyimide Film PIF-1

First, a substrate made of aluminum (hereinafter will be referred to as an aluminum substrate) for forming a coated film of the resin particle and inorganic particle-dispersed polyimide precursor solution is prepared. A surface of the aluminum substrate is washed with toluene and used.

Subsequently, the resin particle and inorganic particle-dispersed polyimide precursor solution (PAA-1) is applied on the aluminum substrate so that a film thickness after drying became about 30 μm, and therefore a coated film is formed and dried at 90° C. for 1 hour. Thereafter, a temperature is raised from room temperature (25° C., hereinafter the same applies) to 400° C. at a rate of 10° C./min, is maintained at 400° C. for 1 hour, and then cooled to room temperature, and therefore a porous polyimide film (PIF-1) having a film thickness of about 25 μm is obtained.

### Examples 20 to 36 and Comparative Examples 6 to 10

A porous polyimide film is produced as same as Example except that the resin particle and inorganic particle-dispersed polyimide precursor solution is changed according to Table 3, and therefore porous polyimide films (PIF-2) to (PIF-18) and (RPIF-1) to (RPIF-5) of the respective examples are obtained.

With respect to the porous polyimide film obtained in each example, ease of peeling from the aluminum substrate after firing, presence or absence of pinholes, and air infiltration rate are evaluated according to the following evaluation method. The results are collectively shown in Table 3.

Evaluation of Peelability from Substrate

The polyimide film fired on the aluminum substrate is immersed into distilled water so as to be peeled off. The peelability is visually evaluated according to the following standard.

Evaluation Standard

A: peeled off within 1 minute after immersion into water

B: peeled off within 10 minutes after immersion into water

C: could not be peeled off within 10 minutes after immersion into water

Evaluation of Pinhole

A sample is collected from the porous polyimide film obtained in each example, 1 cm² square of the sample is visually observed so as to evaluate the number of pinholes penetrating from a surface to a rear surface.

Depending on an application (for example, in a case where the porous polyimide film is applied to an application requiring a large area, such as a separator), a sample of evaluation B tended to be poor in practicality. A sample of evaluation C is particularly poor in practicality.

Evaluation Standard

A: No pinholes

B: 1 or more pinholes and 3 or fewer pinholes

C: 4 or more pinholes

Evaluation of Air Infiltration Rate

The prepared porous polyimide film is cut into a 1 cm² square, and a sample for measuring an air infiltration rate is collected. The sample is set by being put in a funnel and a base of a filter holder for vacuum filtration (KGS-04, manufactured by ADVANTEC). Thereafter, the filter holder in which the sample is put is turned upside down, immersed into water, and filled with water to a predetermined position of the funnel. Air pressure of 0.5 atm (0.05 MPas) is applied from a side where the funnel of the base is not in contact with the base, and a time (sec) at which 50 ml of air passed through is measured and evaluated as the air infiltration rate.

With respect to the samples which are evaluated as B and evaluated as C in the evaluation of pinholes, the measurement is performed while avoiding the pinholes. In addition, it is not possible to perform the measurement in a case where there are too many pinholes. It is not possible to perform the measurement in a case of the absence of the pinholes and in a case where peeling from the substrate is not possible.

TABLE 3

| | | | Peel- | | |
|---|---|---|---|---|---|
| | | | ability | | Air |
| | PI pre- | | from | | infiltra- |
| | cursor | Porous | sub- | Pin- | tion rate |
| Example | solution | PI film | strate | hole | (seconds) |
| Example 19 | PAA-1 | PIF-1 | A | A | 24 |
| Example 20 | PAA-2 | PIF-2 | A | A | 23 |
| Example 21 | PAA-3 | PIF-3 | A | A | 23 |
| Example 22 | PAA-4 | PIF-4 | A | A | 21 |
| Example 23 | PAA-5 | PIF-5 | A | A | 24 |
| Example 24 | PAA-6 | PIF-6 | A | A | 24 |
| Example 25 | PAA-7 | PIF-7 | A | A | 23 |
| Example 26 | PAA-8 | PIF-8 | A | A | 18 |
| Example 27 | PAA-9 | PIF-9 | A | A | 17 |
| Example 28 | PAA-10 | PIF-10 | A | B | 17 |
| Example 29 | PAA-11 | PIF-11 | A | A | 12 |
| Example 30 | PAA-12 | PIF-12 | A | A | 12 |
| Example 31 | PAA-13 | PIF-13 | A | B | 11 |
| Example 32 | PAA-14 | PIF-14 | A | A | 20 |
| Example 33 | PAA-15 | PIF-15 | B | A | 24 |
| Example 34 | PAA-16 | PIF-16 | B | A | 23 |
| Example 35 | PAA-17 | PIF-17 | B | A | 23 |
| Example 36 | PAA-18 | PIF-18 | B | A | 23 |
| Comparative | PAA-R1 | RPIF-1 | C | A | Unable to measure |
| Example 6 | | | | | for being |
| | | | | | unpeelable |
| Comparative | PAA-R2 | RPIF-2 | A | C | Unable to measure |
| Example 7 | | | | | for too many |
| | | | | | pinholes |
| Comparative | PAA-R3 | RPIF-3 | A | C | Unable to measure |
| Example 8 | | | | | for too many |
| | | | | | pinholes |
| Comparative | PAA-R4 | RPIF-4 | A | C | Unable to measure |
| Example 9 | | | | | for too many |
| | | | | | pinholes |
| Comparative | PAA-R5 | RPIF-5 | B | C | Unable to measure |
| Example 10 | | | | | for too many |
| | | | | | pinholes |

Based on the above results, it is understood that in this example, the peelability from the substrate is excellent and the evaluation results of the pinholes are favorable as compared with the comparative example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution comprising:
an aqueous solution that contains water;
a resin particle that does not dissolve in the aqueous solution;
inorganic particles that have a volume average particle diameter within a range of 0.001 μm to 0.2 μm; and
a polyimide precursor.

2. The polyimide precursor solution according to claim 1,
wherein a volume average particle diameter of the resin particles is within a range of 0.1 μm to 1.0 μm and is larger than the volume average particle diameter of the inorganic particles.

3. The polyimide precursor solution according to claim 1,
wherein a volume average particle diameter of the resin particles is within a range of 0.25 μm to 0.98 μm.

4. The polyimide precursor solution according to claim 1,
wherein a mass ratio of the resin particle to the inorganic particle (the resin particle/the inorganic particle) is within a range of 100/100 to 100/0.5.

5. The polyimide precursor solution according to claim 1,
wherein a mass ratio of the resin particle to the inorganic particle (the resin particle/the inorganic particle) is within a range of 100/20 to 100/0.9.

6. The polyimide precursor solution according to claim 1,
wherein the resin particle has an acidic group on a surface of the resin particle.

7. The polyimide precursor solution according to claim 1,
wherein a content of the resin particle is within a range of 20 parts by mass to 600 parts by mass with respect to 100 parts by mass of the polyimide precursor.

8. The polyimide precursor solution according to claim 1,
wherein a content of the resin particle is within a range of 30 parts by mass to 500 parts by mass with respect to 100 parts by mass of the polyimide precursor.

9. The polyimide precursor solution according to claim 1,
wherein a content of the inorganic particle is within a range of 5% by mass to 30% by mass with respect to 100 parts by mass of the polyimide precursor.

10. The polyimide precursor solution according to claim 1,
wherein the inorganic particle is a silica particle.

11. The polyimide precursor solution according to claim 1, further comprising:
an organic amine compound.

12. The polyimide precursor solution according to claim 11,
wherein the organic amine compound is a tertiary amine compound.

13. The polyimide precursor solution according to claim 1,
wherein a volume-based particle size distribution of the resin particles has at least one maximum value, and
a percentage accounting for a volume frequency of particles having a particle diameter two or more times a particle diameter of a maximum value A in which a volume frequency becomes largest among the maximum values, is 5% or less with respect to the volume frequency of the maximum value A.

14. The polyimide precursor solution according to claim 1,
wherein a content of the water is within a range of 50% by mass to 100% by mass with respect to a total amount of the aqueous solution.

15. The polyimide precursor solution according to claim 1,
wherein a content of the water is within a range of 80% by mass to 100% by mass with respect to the total amount of the aqueous solution.

16. A method for producing a porous polyimide film, comprising:
applying the polyimide precursor solution according to claim 1 to form a coated film, and then drying the coated film; and
heating the dried coated film to imidize the polyimide precursor, and removing the resin particle.

17. A porous polyimide film comprising:
the porous polyimide film contains inorganic particles that have a volume average particle diameter within a range of 0.001 μm to 0.2 μm, and
has spherical pores having an average value of a pore diameter of 1.0 μm or smaller.

18. The porous polyimide film according to claim 17,
wherein an air infiltration rate of the porous polyimide film is within a range of 10 seconds to 30 seconds.

19. The porous polyimide film according to claim 17,
wherein a content of the inorganic particle is within a range of 5% by mass to 30% by mass with respect to a total content of the porous polyimide film.
